(19) United States
(12) Patent Application Publication
(10) Pub. No.: US 2014/0122101 A1
(43) Pub. Date: May 1, 2014

(54) HEALTH MANAGEMENT APPARATUS, HEALTH MANAGEMENT METHOD, AND HEALTH MANAGEMENT PROGRAM

(71) Applicant: HITACHI, LTD., Tokyo (JP)

(72) Inventors: Ryo FUKUMARU, Tokyo (JP); Takuya AKASHI, Kokubunji (JP); Kazuhiro IKEGAYA, Tokyo (JP)

(73) Assignee: HITACHI, LTD., Tokyo (JP)

(21) Appl. No.: 13/832,985

(22) Filed: Mar. 15, 2013

(30) Foreign Application Priority Data
Oct. 26, 2012 (JP) 2012-236259

(51) Int. Cl. G06F 19/00

(52) U.S. Cl. CPC G06F 19/3418
USPC 705/2

(57) ABSTRACT

A health care apparatus includes a storage unit to store first, second and third information groups which are respectively sets of a plurality of schedule information pieces, biological system information pieces, and comment information pieces, and a controller to associate individual information pieces respectively included in the first, second, and third information groups with each other on the basis of coincidence or resemblance among words included in the individual information pieces, The controller displays the first, second, and third information groups respectively in first, second, and third areas of a screen on an output device connected to the controller. The controller accepts arbitrary one selected out of the individual information pieces included in the first, the second, or the third information group. The controller displays other individual information pieces associated with the selected individual information piece with emphasis.

### CLAIM OF PRIORITY

The present application claims priority from Japanese patent application JP 2012-236259 filed on Oct. 26, 2012, the content of which is hereby incorporated by reference into this application.

### BACKGROUND OF THE INVENTION

The present invention relates to a health care apparatus, a health care method, and a health care program.

Recently, a technique for bringing about a good understanding between a patient and a doctor about health care by utilizing a computer is widely put to practical use. For example, a health care support system disclosed in JP-A-2004-54564 displays biological information which is input by a patient via a patient terminal device, on a doctor terminal device, and displays a message which is input by a doctor via the doctor terminal device. In addition, the health care support system associates pattern messages with classification items including items of biological information.

### SUMMARY OF THE INVENTION

While viewing biological information such as, for example, a patient's temperature, the patient thinks as to what is a doctor's view on the biological information and an action to be taken by the patient in order to improve the health state. For example, the health care support system disclosed in JP-A-2004-54564 displays a message issued by a doctor to a patient, and the message is selected from among pattern messages. And pattern messages are associated with an item of biological information which is input by the patient (paragraphs 0010 to 0015).

However, the health care support system disclosed in JP-A-2004-54564 does not display a relation of specific biological information to the doctor's view and an action to be taken intelligibly at a glance. In addition, the health care support system displays a list of a large amount of biological information. When a patient wants to pay attention to specific biological information, therefore, the patient cannot help viewing even redundant information at the same time.

Therefore, an object of the present invention is to display relations among specific biological information, a doctor's view concerning the biological information, and actions to be taken, as much as required.

A health care apparatus according to the present invention includes a storage unit for storing a first information group which is a set of a plurality of schedule information pieces, a second information group which is a set of a plurality of biological system information pieces, and a third information group which is a set of a plurality of comment information pieces, and a controller for associating individual information pieces included in the first information group, individual information pieces included in the second information group, and individual information pieces included in the third information group with each other on the basis of coincidence or resemblance among words included in the individual information pieces, for displaying the first information group in a first area of a screen on an output device connected to the controller, for displaying the second information group in a second area of the screen, for displaying the third information group in a third area of the screen, for accepting arbitrary one selected out of the individual information pieces included in the first information group, the second information group, or the third information group, and for displaying other individual information pieces associated with the selected individual information piece with emphasis.

Other units will be described in “DESCRIPTION OF THE EMBODIMENTS.”

According to the present invention, it becomes possible to display relations among specific biological information, a doctor's view concerning the biological information, and actions to be taken, as much as required.

Other objects, features and advantages of the invention will become apparent from the following description of the embodiments of the invention taken in conjunction with the accompanying drawings.

### BRIEF DESCRIPTION OF THE DRAWINGS

FIG. 1 is a configuration diagram of a health care system in an embodiment;

FIG. 2 is a configuration diagram of a patient terminal device and so on in the present embodiment;

FIG. 3 is a configuration diagram of an agent terminal device in the present embodiment;

FIG. 4A shows an example of a family information DB (database) in the present embodiment, and FIG. 4B shows an example of a supporter information DB (database) in the present embodiment;

FIG. 5 shows an example of a biological information DB in the present embodiment;

FIG. 6 shows an example of an observation information DB in the present embodiment;

FIG. 7 shows an example of a hospital attending information DB in the present embodiment;

FIG. 8 shows an example of a medicine taking information DB in the present embodiment;

FIG. 9 shows an example of a comment information DB in the present embodiment;

FIG. 10A shows an example of an associating information DB in the present embodiment, and FIG. 4B shows an example of a perusal authority information DB in the present embodiment;

FIG. 11 shows an example of a (personal) health care screen in the present embodiment;

FIG. 12 shows an example of a (personal) health care screen in the present embodiment;

FIG. 13 shows an example of a (personal) health care screen in the present embodiment;

FIG. 14 shows an example of a (personal) health care screen in the present embodiment;

FIG. 15 shows an example of a (personal) health care screen in the present embodiment;

FIG. 16 shows an example of a (personal) health care screen in the present embodiment;

FIG. 17 shows an example of a (personal) health care screen in the present embodiment;

FIG. 18 shows an example of a (personal) health care screen in the present embodiment;

FIG. 19 shows an example of a (personal) health care screen in the present embodiment;

FIG. 20 shows an example of an interactive screen in the present embodiment;

FIG. 21 shows an example of an advice tree;

FIG. 22 is a flow chart of a general processing procedure in the present embodiment;

FIG. 23A is a flow chart of a biological information & observation information input processing procedure in the present embodiment, FIG. 23B is a flow chart of a hospital attending information & medicine taking information input processing procedure in the present embodiment, and FIG. 23C is a flow chart of a comment information input processing procedure in the present embodiment;

FIG. 24A is a flow chart of an associating processing procedure in the present embodiment, and FIG. 24B is a flow chart of a health care processing procedure in the present embodiment; and

FIG. 25A is a flow chart of a perusal authority reconsideration processing procedure in the present embodiment, and FIG. 25B is a flow chart of an interactive processing procedure in the present embodiment.

### DESCRIPTION OF THE EMBODIMENTS

Hereafter, an embodiment for implementing the present invention (referred to as “the present embodiment”) will be described with reference to the drawings. First, meanings of terms used in the present embodiment and an outline of the present invention will be described.

### <<Meanings of Terms>>

Biological information (bio-information) is quantitative information concerning a human body such as, for example, the following information.
Information (INF) which can be acquired immediately by using a measuring instrument, such as the weight, height, temperature, highest (lowest) blood pressure, and pulse rate
Information which can be acquired by analyzing a sample picked from a body, such as the blood sugar level
Information which indicates a capacity for locomotion such as the 50 meter running (time)
Information obtained by adding up the daily actions such as the sleeping hours and caloric intake

Observation information is qualitative information concerning a human body such as, for example, the following information.
Information which can be perceived by the person himself or herself such as whether the physical condition is good or bad and whether there is a headache
Information which can be sensed by those around one such as whether the one is in a good humor

Hospital attending information is information which indicates a schedule of being treated by a doctor (DR) or the like, such as the following information
Diagnosis in a doctor's office
Vaccination in a school, a doctor's office, or the like

Medicine taking information is information which indicates a schedule of taking medicine instructed by a doctor or the like or information which indicates a schedule of taking exercise instructed by a doctor or the like. Examples of the medicine taking information are as follows.
“A-metec (medicine name)•after lunch on October 14”
“Radio exercises• on the early morning of October 14”

Comment information is composition information made by a doctor or the like, for example, as follows.
A message such as “The blood pressure value is high. Leaving as it is brings about a serious disease. Consult, please”
A report such as a medical checkup result

Biological system information is a wide concept including the biological information and the observation information. Schedule information is a wide concept including hospital attending information and medicine taking information. A patient is a human who receives health guidance regardless of the age and whether there is an actual disease (even a healthy person is called patient).

A supporter is a specialist who gives health guidance to a patient, for example, as follows.
A person engaged in medical treatment who accepts unspecific patients widely and generally, such as a doctor and a pharmacist
A person engaged in medical treatment who accepts patients belonging to a specific organization (such as an enterprise, a school, or a day nursery) such as an industrial doctor, a school doctor, or a nursery attendant

A home doctor is a specialist who gives health guidance to a group of patients such as a family from a purely medical viewpoint. A doctor gives health guidance on the basis of direct medical examination (exam) on a patient. However, the home doctor is not necessarily demanded to directly examine a patient. The home doctor rather gives health guidance to all members of a specific family comprehensively and objectively. As a matter of course, the home doctor may be a “doctor” by profession.

An agent is a specialist who gives health guidance to a group of patients such as a family from a viewpoint other than the purely medical viewpoint. The viewpoint other than the purely medical viewpoint is an economic or home economic viewpoint such as, for example, the cost analysis of fees for medical treatment. The occupation of the agent is not especially restricted.

By the way, a plurality of pieces of schedule information, a plurality of pieces of biological system information, and a plurality of pieces of comment information correspond to a “first information group,” a “second information group,” and a “third information group,” respectively.

It is supposed that a family is composed of a husband (a wage earner), a wife (inoccupation), the oldest son (a schoolboy), and the oldest daughter (a suckling). The husband has abundant opportunities to receive health guidance from an industrial doctor in his place of work. The wife often receives health guidance from her family doctor. The oldest son (or his parent) often receives health guidance from a school doctor of his grade school. The (parent of the) oldest daughter often receives health guidance from a nursery attendant in a day nursery. It is convenient for a person who represents the family, for example, the husband to know health guidance received by the family members from respective supporters (the industrial doctor, the doctor, the school doctor, and the nursery attendant). However, it is further convenient to receive comprehensive objective health guidance for the whole family members collectively from a home doctor who is independent of respective supporters. If the husband is in a position to bear fees for medical treatment of all family members, it is further convenient for the husband to receive health guidance from the agent and reconsider the medical treatment plan. Significance of existence of the home doctor and the agent is present in this point.

### <<Outline of the Present Invention>>

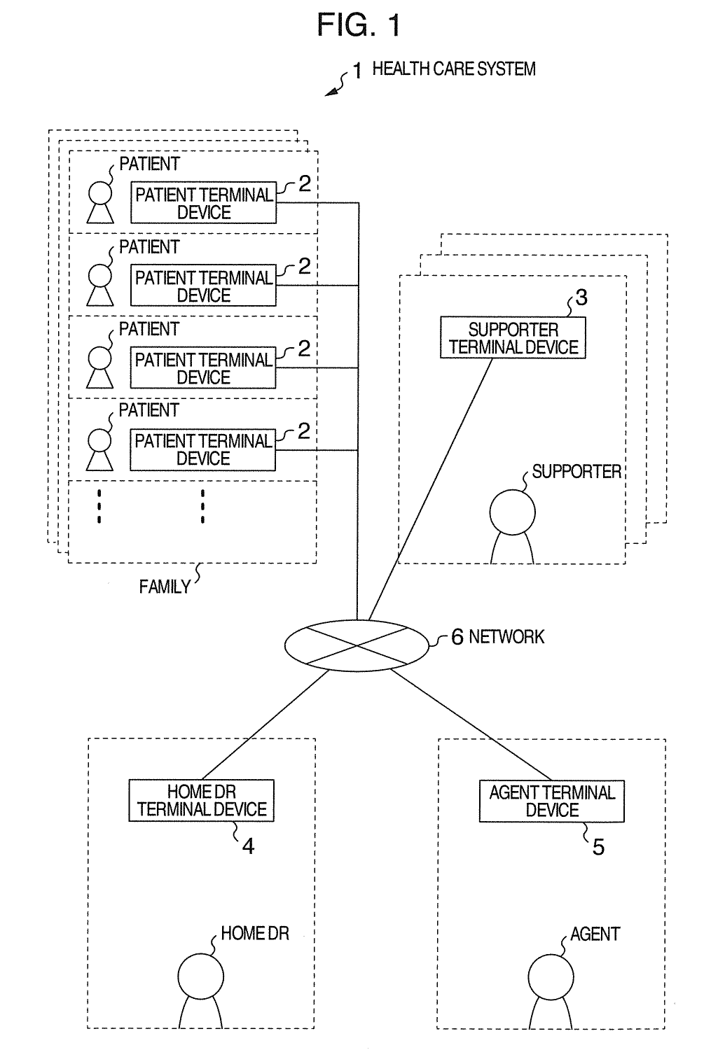

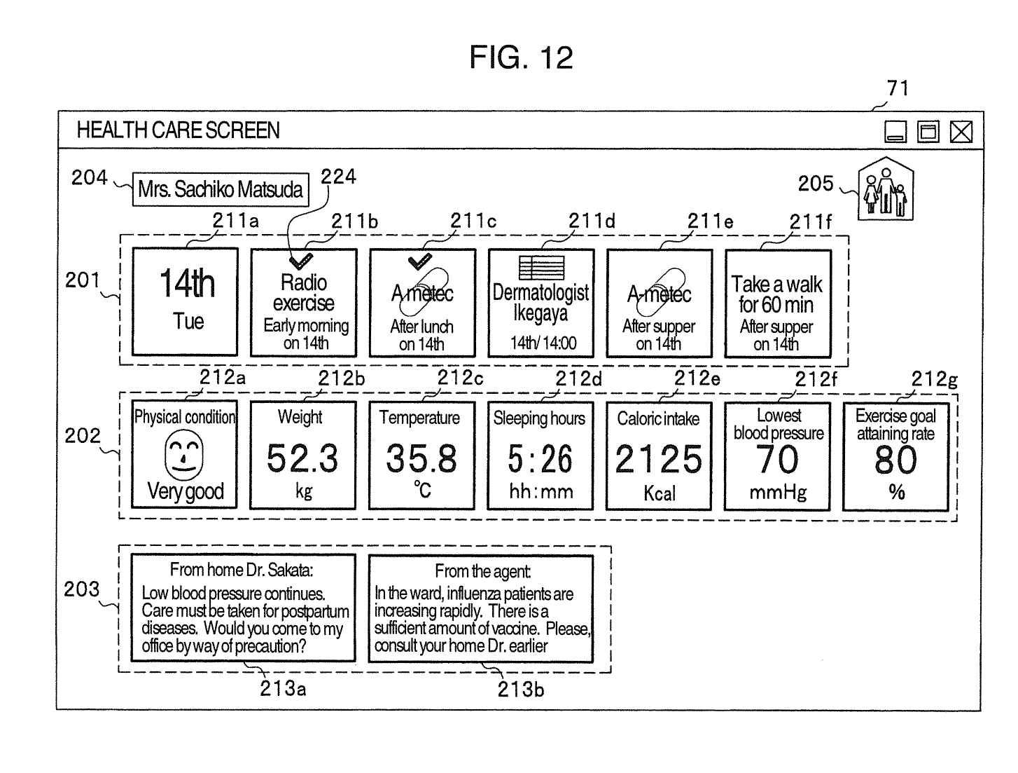

For easy understanding, a representative embodiment of the present invention will now be described with reference to a health care screen 71 (FIG. 12), skipping FIGS. 1 to 11 for a while. It is now supposed that one of patients, Sachiko Matsuda is viewing the health care screen 71. On the health care screen 71, tile-shaped figures (hereafter referred to simply as “tiles” in some cases) are displayed sideways along a line over three rows: an upper row 201, a middle row 202, and a lower row 203.

Tiles 211a to 211f indicating the schedule information (hospital attending information and medicine taking information) are displayed in the upper row 201 (a first area) The tile 211a indicates that this day is the 14th and Tuesday. The tile 211b indicates that Sachiko Matsuda already conducted the radio exercise on the early morning of this day. By the way, a check mark 224 indicates that the schedule is already completed. The tile 211c indicates that Sachiko Matsuda already took medicine named “A-metec” after lunch this day. The tile 211d indicates that Sachiko Matsuda is scheduled to receive treatment in “dermatologist Dr. Ikegaya's office” at 14:00 this day. The tile 211e indicates that Sachiko Matsuda is scheduled to take medicine named “A-metec” after supper this day. The tile 211f indicates that Sachiko Matsuda is scheduled to take a walk for 60 minutes after supper this day.

Tiles 212a to 212g indicating the biological system information (biological information and observation information) are displayed in the middle row 202 (a second area). The tile 212a indicates that the physical condition of Sachiko Matsuda is very good. The tile 212b indicates that the weight of Sachiko Matsuda is 52.3 kg. The tile 212c indicates that the temperature of Sachiko Matsuda is 35.8° C. The tile 212d indicates that the sleeping hours of Sachiko Matsuda is 5 hours and 26 minutes. The tile 212e indicates that the caloric intake of Sachiko Matsuda is 2,125 kcal. The tile 212f indicates that the lowest blood pressure of Sachiko Matsuda is 70 mmHg. The tile 212g indicates that the exercise goal attaining rate of Sachiko Matsuda is 80%.

Tiles 213a and 213b indicating comment information are displayed in the lower row 203 (a third area). The tile 213a indicates contents of a comment made by the home doctor. The tile 213b indicates contents of a comment made by the agent. Sachiko Matsuda is annoyed by symptoms of low blood pressure. Therefore,

Sachiko Matsuda is seeking for an answer to a question as to what action should be taken and what advice should be received in order to cure it. In a state in which the tiles are displayed redundantly as shown in FIG. 12, however, it is difficult for Sachiko Matsuda to find an answer instantaneously. It is now supposed that only the tile 211e and the tile 213a are displayed with emphasis or other tiles are brought into a non-display state when Sachiko Matsuda touches the tile 212f “the lowest pressure 70 mmHg” with a finger. Thereupon, Sachiko Matsuda can instantaneously find an answer that she must first take “A-metec” after lunch and must receive health guidance from the home doctor in the near future.

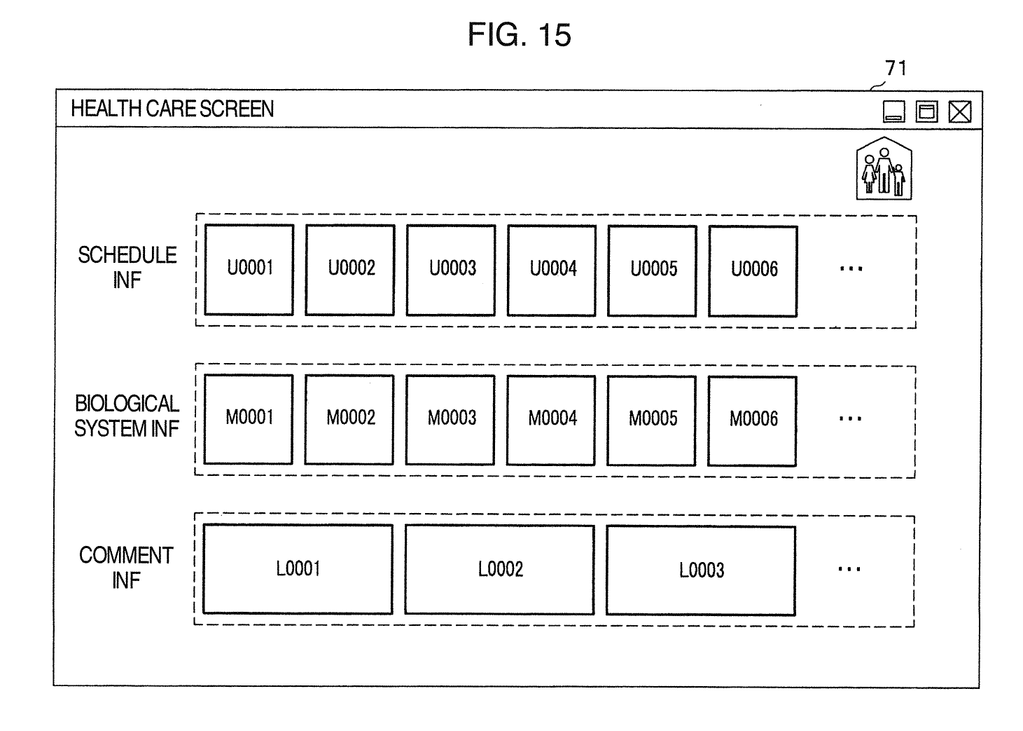

Above-described contents will now be described more generally with reference to FIGS. 15 to 18. In an upper row of the health care screen 71 (FIG. 15), tiles indicating the schedule information are displayed sideways along a line. In a middle row, tiles indicating the biological system information are displayed sideways along a line. In a lower row, tiles indicating the comment information are displayed sideways along a line.

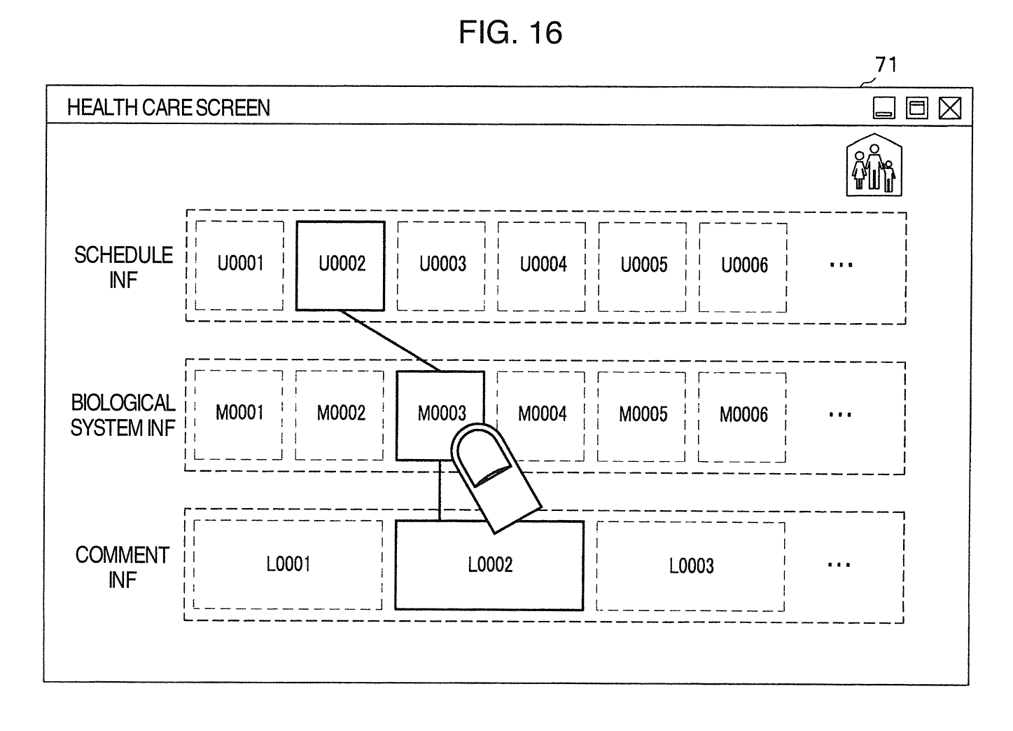

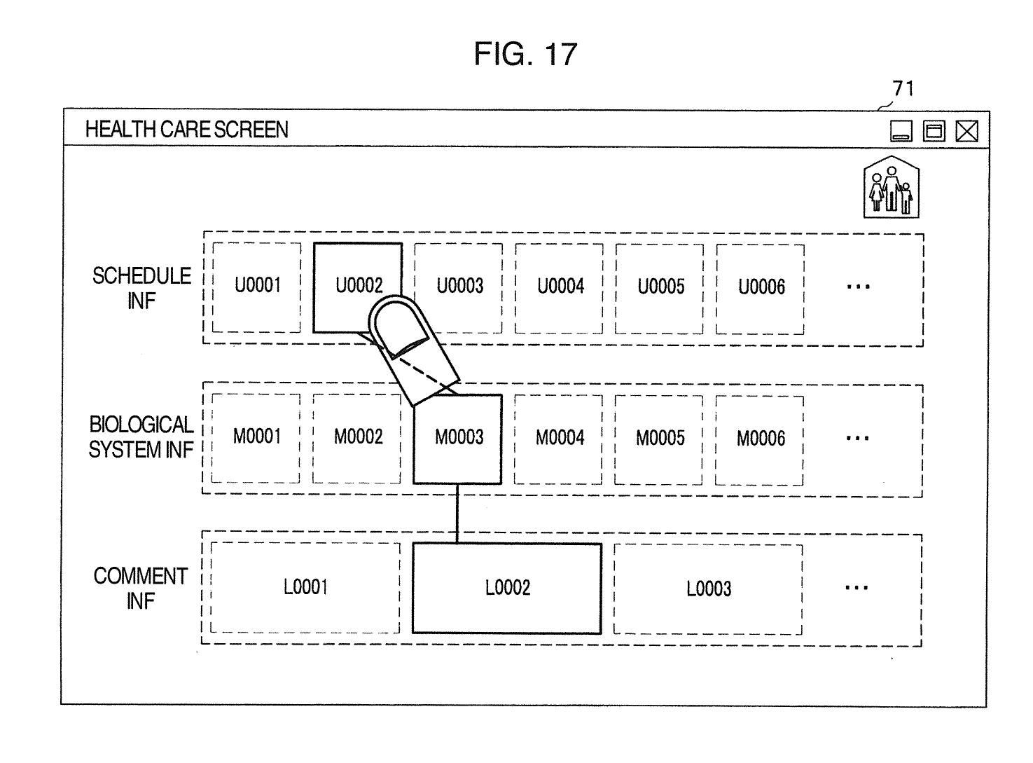

It is now supposed that a patient touches a tile “M0003” in the middle row with a finger. Thereupon, a tile “U0002” in the upper row, a tile “M0003” in the middle row, and a tile “L0002” in the lower row are displayed with emphasis (FIG. 16). As another example, it is supposed that the patient touches the tile “U0002” in the upper row with a finger. Thereupon, the tile “U0002” in the upper row, the tile “M0003” in the middle row, and the tile “L0002” in the lower row are displayed with emphasis in the same way (FIG. 17).

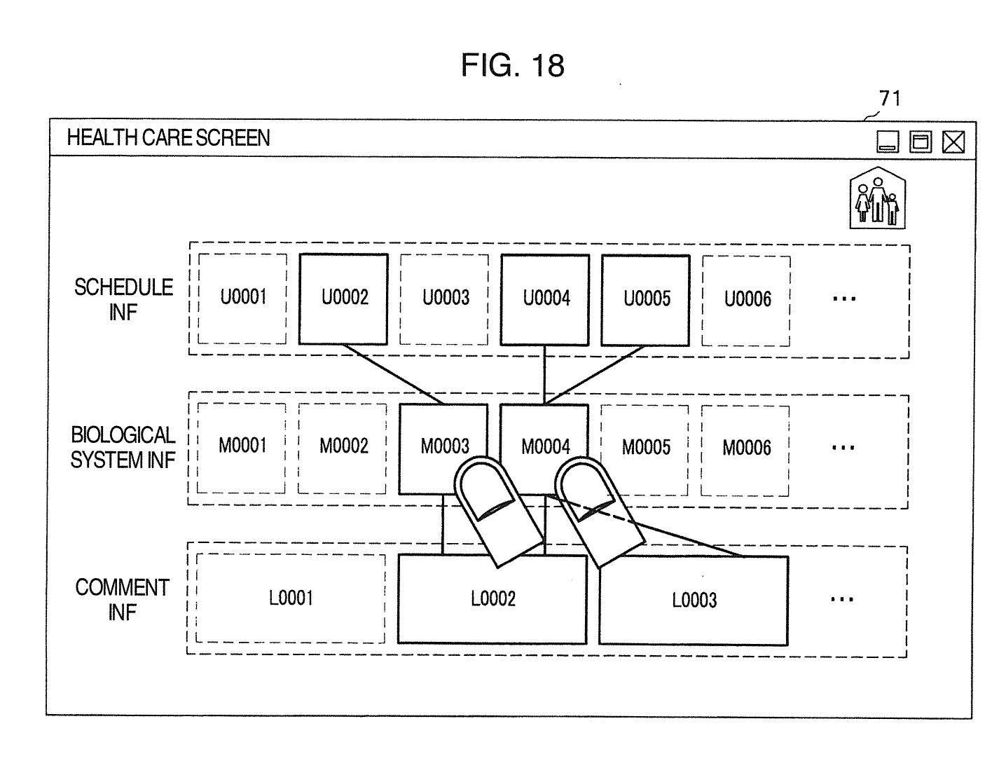

As a further example, it is supposed that the patient touches the tile “M0003” and a tile “M0004” in the middle row with a finger. Thereupon, the tile “U0002” in the upper row, the tile “M0003” in the middle row, and the tile “L0002” in the lower row are displayed with emphasis in a certain mode (for example, using a red color). And tiles “U0004” and “U0005” in the upper row, the tile “M0004” in the middle row, and the tile “L0002” and a tile “L0003” in the lower row are displayed with emphasis in a different mode (for example, using a yellow color) (FIG. 18). The overlapping tile “L0002” in the lower row may be displayed with emphasis using a red color for its left half and a yellow color for its right half.

In other words, one piece or a plurality of pieces of information (individual information) belonging to a group of schedule information, one piece or a plurality of pieces of information (individual information) belonging to a group of biological system information, and one piece or a plurality of pieces of information (individual information) belonging to a group of comment information are associated with each other and stored. And if a tile indicating arbitrary information is selected, tiles indicating information associated with the selected information are displayed with emphasis at a rate of one or a plurality of pieces per group.

### <<Device Configuration>>

A configuration of a health care system 1 will now be described with reference to FIG. 1. The health care system 1 includes a patient terminal device 2, a supporter terminal device 3, a home doctor terminal device 4, and an agent terminal device 5, which are connected to each other via a network 6. These devices 2 to 5 are operated by patients belonging to a family, a supporter, a home doctor and an agent, respectively.

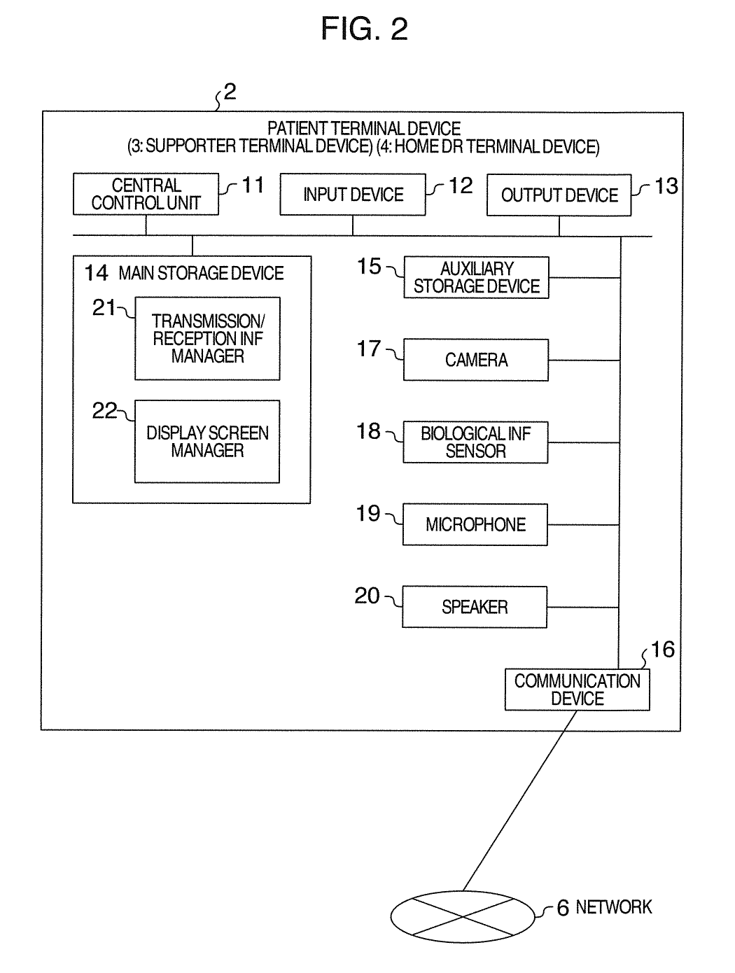

A configuration of the patient terminal device 2 will now be described with reference to FIG. 2. The patient terminal device 2 is a general computer. The patient terminal device 2 includes a central control unit 11, an input device 12 such as a keyboard, mouse and a touch screen, an output device 13 such as a display, a main storage device 14, an auxiliary storage device 15, a communication device 16, a camera 17, a biological information sensor 18, a microphone 19, and a speaker 20. They are connected to each other by a system bus. The patient terminal device 2 may be the so-called personal computer for operation on desk top, or the so-called portable tablet or smart phone.

A transmission/reception information manager 21 and a display screen manager 22 in the main storage device 14 are programs. Hereafter, if an expression “ - - - manager (accepts, acquires or the like)” is described in a subject form, the central control unit 11 reads out each program from the auxiliary storage device 15, loads the program into the main storage device 14, and then implements a function (described in detail later) of the program. (The same is true of the agent terminal device 5 which will be described later.) As for the components 11 to 16 generally included in the computers, detailed description will be omitted.

The camera 17 acquires an image (a still picture or a moving picture) of a patient who is an object. The biological information sensor 18 is a measuring instrument such as, for example, an electronic sphygmomanometer, an electronic thermometer, or an electronic scale. The biological information sensor 18 acquires biological information of the patient. The microphone 19 acquires a voice uttered by the patient. The speaker 20 reproduces a voice of the other party with who the patient communicates. The supporter terminal device 3 and the home doctor terminal device 4 also have a similar configuration. However, the biological information sensor 18 in the supporter terminal device 3 acquires biological information of not the supporter but the patient. For example, the nursery attendant acquires biological information of the suckling. The same is true of the home doctor terminal device 4.

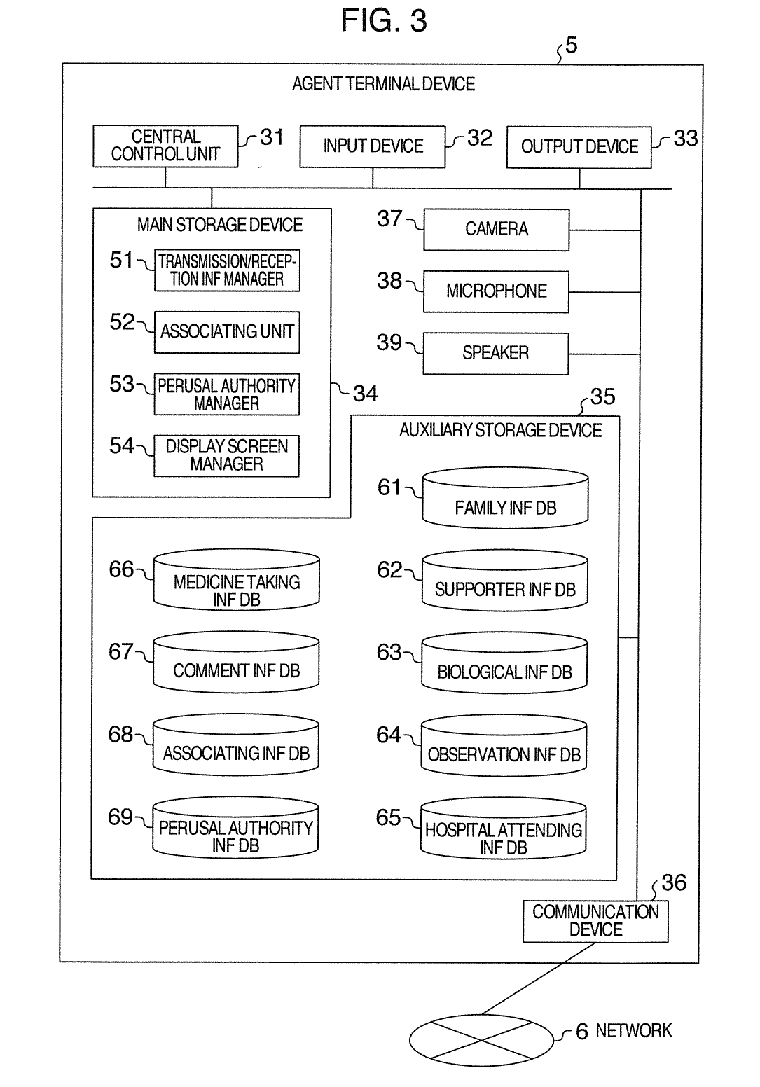

A configuration of the agent terminal device 5 will now be described with reference to FIG. 3. The agent terminal device 5 is also a general computer. The agent terminal device 5 includes a central control unit 31, an input device 32 such as a keyboard, a mouse, and a touch screen, an output device 33 such as a display, a main storage device 34, an auxiliary storage device 35, a communication device 36, a camera 37, a microphone 38, and a speaker 39. They are connected to each other by a system bus. The agent terminal device 5 may be the so-called personal computer for operation on desk top, or the so-called portable tablet or smart phone. In many cases, however, the agent terminal device 5 is a personal computer for operation on desk top. Detailed description of the components 31 to 39 will be omitted.

A transmission/reception information manager 51, an associating unit 52, a perusal authority manager 53, and a display screen manager 54 in the main storage device 34 are programs. The auxiliary storage device 35 stores a family information database 61 (hereafter “database” is abbreviated to “DB” in some cases), a supporter information DB 62, a biological information DB 63, an observation information DB 64, a hospital attending information DB 65, a medicine taking information DB 66, a comment information DB 67, an associating information DB 68, and a perusal authority information DB 69. Hereafter, details of them will be described. By the way, the agent terminal device 5 is equivalent to the “health care apparatus.”

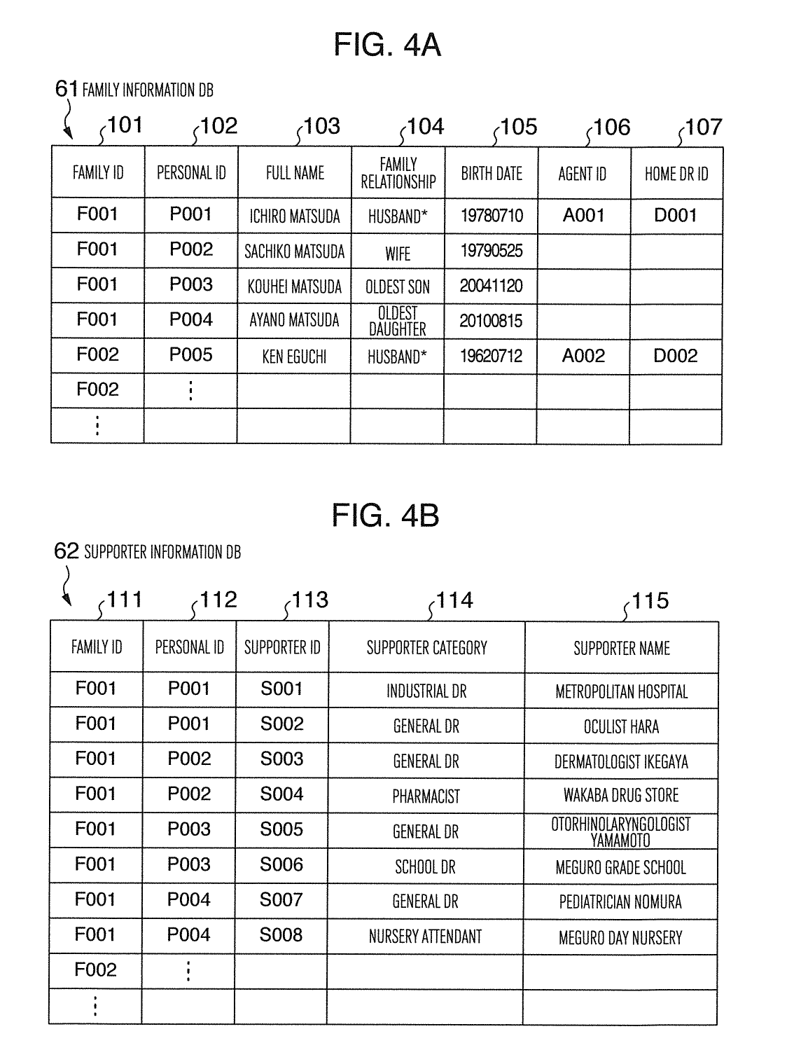

The family information DB 61 will now be described with reference to FIG. 4A. In the family information DB 61, a personal ID is stored in a personal ID column 102 in association with a family ID stored in a family ID column 101. A full name is stored in a full name column 103 in association with the family ID. A family relationship is stored in a family relationship column 104 in association with the family ID. A birth date is stored in a birth date column 105 in association with the family ID. An agent ID is stored in an agent ID column 106 in association with the family ID. A home doctor ID is stored in a home doctor ID column 107 in association with the family ID.

The family ID in the family ID column 101 is an identifier which uniquely identifies a family to which a patient belongs. The “family” is entirely a unit for managing a plurality of patients. It doesn't matter whether there is a legal kinship between patients belonging to the family or whether they live in the same house or in separate houses.

The personal ID in the personal ID column 102 is an identifier which uniquely identifies a patient.

The full name in the full name column 103 is a full name of a patient.

The family relationship in the family relationship column 104 is a term which indicates a kinship of a patient in the family. “Husband,” “wife,” “the oldest son” and “the oldest daughter” are described as examples. The family relationship may be “second son,” “second daughter,” “husband's mother,” “the oldest son of the oldest son” or the like. By the way, “*” attached to a family relationship represents that the patient is a representative (one person) in the family.

The birth date in the birth date column 105 is a birth date of the patient.

The agent ID in the agent ID column 106 is an identifier which uniquely identifies an agent. The agent is a person who gives health guidance to all members of the family. Therefore, the agent ID is stored only in a record of the representative.

The home doctor ID in the home doctor ID column 107 is an identifier which uniquely identifies a home doctor. The home doctor is also a person who gives health guidance to all members of the family. Therefore, the home doctor ID is also stored only in the record of the representative.

In the family information DB 61, there are as many records as the number of personal IDs. Paying attention to first to fourth lines, “Ichiro Matsuda” who is “husband” and a representative as well, “Sachiko Matsuda” who is “wife,” “Kouhei Matsuda” who is “the oldest son,” and “Ayano Matsuda” who is “the oldest daughter” belong to a family having a family ID “F001.” Supposing that it is the year 2012 at the present time, “Kouhei Matsuda” is a school boy and “Ayano Matsuda” is a suckling according to the birth date shown in FIG. 4A.

The supporter information DB 62 will now be described with reference to FIG. 4B. In the supporter information DB 62, a personal ID is stored in a personal ID column 112 in association with a family ID stored in a family ID column 111. A supporter ID is stored in a supporter ID column 113 in association with the family ID. A supporter category is stored in a supporter category column 114 in association with the family ID. A supporter name is stored in a supporter name column 115 in association with the family ID.

The family IDs in the family ID column 111 are the same as the family IDs shown in FIG. 4A.

The personal IDs in the personal ID column 112 are the same as the personal IDs shown in FIG. 4A.

The supporter ID in the supporter ID column 113 is an identifier which uniquely identifies a supporter.

The supporter category in the supporter category column 114 is a term which indicates a kind of the supporter. As the supporter category here, “industrial doctor,” “general doctor (distinguished from home doctor),” “pharmacist,” “school doctor,” and “nursery attendant” are shown as examples. The supporter category may be “acupuncturist and moxa-cauterizer,” “certified care worker” or the like. The supporter category may be “physician” obtained by classifying general doctor more finely.

The supporter name in the supporter name column 115 is a name of the supporter. The supporter name may be a personal name or an association name such as a style.

In the supporter information DB 62, there are as many records as the number of combinations of personal Ds and supporter IDs of supporters who examine patients having the personal IDs.

The following facts are found by referring to examples shown in FIGS. 4A and 4B.
“Ichiro Matsuda,” “Sachiko Matsuda,” “Kouhei Matsuda,” and “Ayano Matsuda” receive personal health guidance respectively from “oculist Hara” “dermatologist Ikegaya” “otorhinolaryngologist Yamamoto” and “pediatrician Nomura” who are “general doctors.”
Besides, “Ichiro Matsuda” also receives personal health guidance from “Metropolitan general hospital” which is an “industrial doctor.” “Sachiko Matsuda” also receives personal health guidance from “Wakaba prescription filling drug store” which is “pharmacist.” “Kouhei Matsuda” also receives personal health guidance from “Meguro grade school” which is “school doctor.” “Ayano Matsuda” also receives personal health guidance from “Meguro day nursery” which is “nursery attendant.”
In addition, the agent “A001” and the home doctor “D001” give health guidance to “Ichiro Matsuda,” “Sachiko Matsuda,” “Kouhei Matsuda,” and “Ayano Matsuda.”

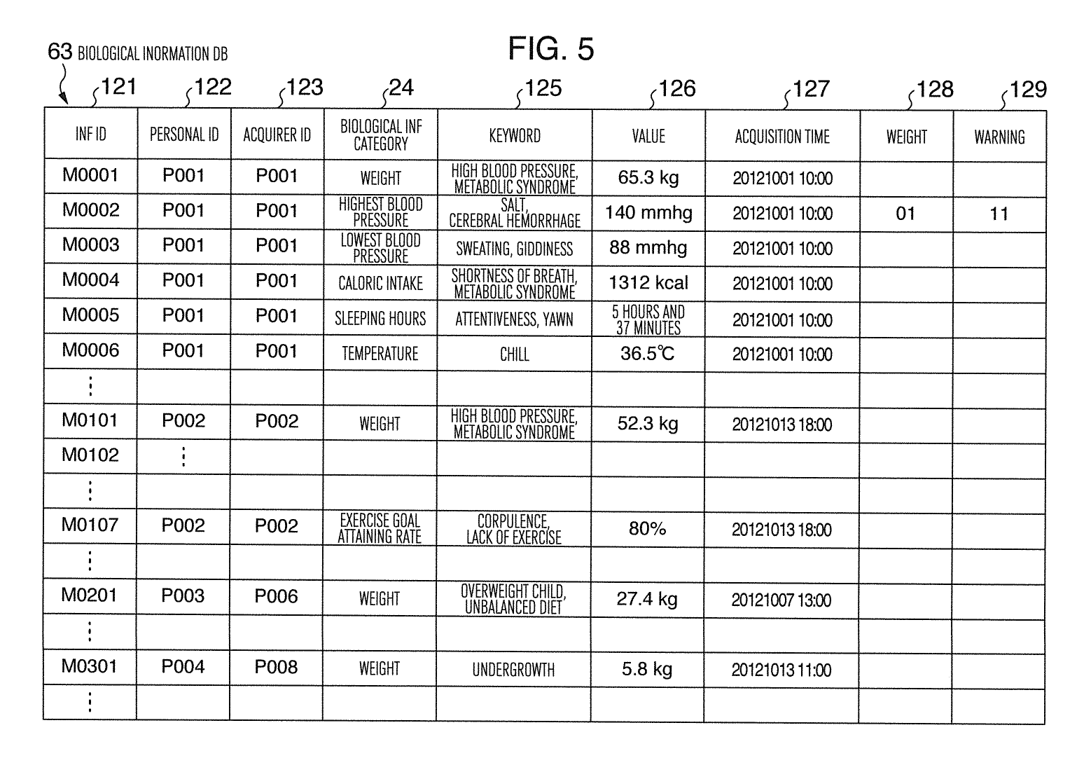

The biological information DB 63 will now be described with reference to FIG. 5. In the biological information DB 63, a personal ID is stored in a personal ID column 122 in association with an information ID stored in an information ID column 121. An acquirer ID is stored in an acquirer ID column 123 in association with the information ID. A biological information category is stored in a biological information category column 124 in association with the information ID. Keywords are stored in a keyword column 125 in association with the information ID. A value is stored in a value column 126 in association with the information ID. An acquisition time is stored in an acquisition time column 127 in association with the information ID. A weight code is stored in a weight column 128 in association with the information ID. A warning code is stored in a warning column 129 in association with the information ID.

The information ID in the information ID column 121 is an identifier which uniquely identifies information (individual information) throughout all of the biological information, the observation information, the hospital attending information, the medicine taking information, and the comment information. The information ID has a configuration of a symbol+a numerical value like, for example, “M0001.” The “M” is an abbreviation of “middle” and it indicates that a tile representing the information is displayed in a line in the middle row of the health care screen 71. “0001” is a unique numeral among information IDs having “M” as a prefix. In the present embodiment, “M” is assigned to the biological information and the observation information. And “0001 to 1000” are assigned to the biological information, and “1001- - - ” are assigned to the observation information. Hereafter, information IDs having “M” as a prefix are referred to as M system information IDs sometimes.

Personal IDs in the personal ID column 122 are the same as the personal IDs shown in FIG. 4A.

The acquirer ID in the acquirer ID column 123 is an identifier which uniquely identifies a person who has acquired biological information. Specifically, the acquirer ID in the acquirer ID column 123 is a personal ID of a patient who has acquired biological information of himself or herself or a supporter ID of a supporter (such as a nursery attendant) who has acquired biological information of a patient (such as a suckling).

The biological information category in the biological information category column 124 represents a kind of biological information. Here, “weight,” “the highest blood pressure,” “the lowest blood pressure,” “temperature,” “caloric intake,” “sleeping hours,” and “exercise goal attaining rate” (such as, for example, an attaining rate relative to a walking goal of 5,000 steps/day) are indicated as examples. However, other biological information categories such as the “height,” “pulse rate” and “blood sugar level” may also be used.

The keywords in the keyword column 125 will be described in detail collectively later (because it is an item common to other DBs).

The value in the value column 126 is an acquired value of biological information.

The acquisition time in the acquisition time column 127 represents a minute, an hour, and a date when the biological information is acquired.

The weight code in the weight column corresponds to a “weight” caused when a tile is dragged (pressed and moved with a finger) on the health care screen 71 in the case where biological information is at a dangerous level. The “weight” is a ratio of a distance over which a patient dragged the tile on the screen to a distance obtained by subtracting a distance over which the tile actually moves on the screen from the drag distance. For example, if the tile display on the screen actually moves only one unit although the patient moves the tile four units, the “weight” is (4−1)/4=0.75. Here, the “unit” may be, for example, pixel or a length on the screen.

The warning code in the warning column 129 indicates an emphasis mode in displaying the tile on the health care screen 71 when biological information is at a dangerous level.

Examples of the weight code and the warning code of the highest blood pressure will now be described more specifically. It is now supposed that a “caution threshold” is “130 mmHg” and a “danger threshold” is “140 mmHg.” The transmission/reception information manager 51 in the agent terminal device 5 monitors the value of the highest blood pressure on the biological information DB 63 at all times or periodically. If the value arrives at the danger threshold even momentarily, the transmission/reception information manager 51 stores a weight code “01” in the weight column 128. If a time period over which the value exceeds the “caution threshold” continues for a predetermined time (for example, one month) although the value does not arrive at the “danger threshold,” the transmission/reception information manager 51 stores a weight code “02” in the weight column 128 of a record having a first acquisition time which is one month later. By the way, the weight code “01” may correspond to “weight=0.5” and the weight code “02” may correspond to “weight=0.2.”

The warning code in the warning column 129 corresponds to a mode in conducting warning display of a tile on the health care screen 71 in the case where biological information is at a dangerous level.

For example, if the value arrives at a danger threshold even in a moment, the transmission/reception information manager 51 in the agent terminal device 5 stores a warning code “11” in the warning column 129. If a time period over which the value exceeds the “caution threshold” continues for a predetermined time (for example, one month) although the value does not arrive at the “danger threshold,” the transmission/reception information manager 51 stores a warning code “12” in the warning column 129 of a record having a first acquisition time which is one month later. By the way, the warning code “12” may correspond to yellow emphasis display and the warning code “11” may correspond to red emphasis display which gives a greater sense of urgency.

The caution threshold and the danger threshold may also be set every biological information category and every patient (every personal ID).

In the biological information DB 63, there are as many records as the number of acquired values. For example, the following facts are found by paying attention to FIG. 5 and referring to FIGS. 4A and 4B as occasion demands (the keyword will be described later).
Ichiro Matsuda acquired a value of the weight himself at ten o'clock on Oct. 1, 2012, and the value was 65.3 kg.
At the same time, Ichiro Matsuda acquired values of the highest blood pressure, the lowest blood pressure, the caloric intake, the sleeping hours, and the temperature as well.
Among them, the value of the highest blood pressure arrived at the danger threshold. Therefore, the weight code “01” was stored in the weight column 128, and the warning code “11” was stored in the warning column 129.
The “school doctor” in “Meguro grade school” acquired a value of the weight of Kouhei Matsuda at 13 o'clock on Oct. 7, 2012, and the value was 27.4 kg.

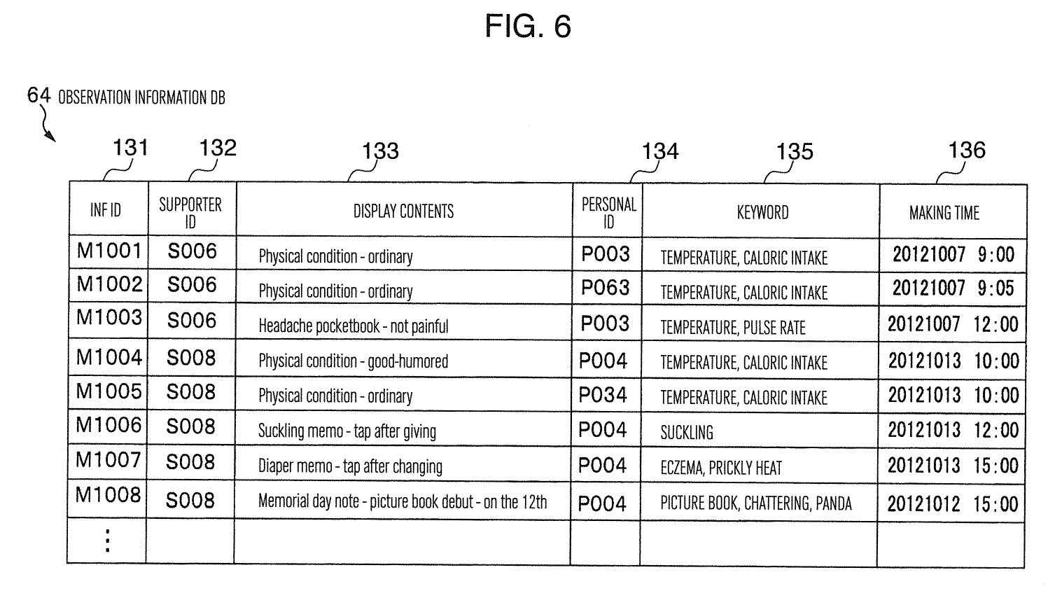

The observation information DB 64 will now be described with reference to FIG. 6. In the observation information DB 64, a supporter ID is stored in a supporter ID column 132 in association with an information ID stored in an information ID column 131. Display contents are stored in a display content column 133 in association with the information ID. A personal ID is stored in a personal ID column 134 in association with the information ID. Keywords are stored in a keyword column 135 in association with the information ID. A making time is stored in a making time column 136 in association with the information ID.

The information IDs in the information ID column 131 are the same as the information IDs shown in FIG. 5.

The supporter IDs in the supporter ID column 132 are the same as the supporter IDs shown in FIG. 4B.

The display contents in the display content column 133 are characters and the like displayed in the tiles as the observation information.

The personal IDs in the personal ID column 134 are the same as the personal IDs shown in FIG. 4A.

The keywords in the keyword column 135 will be described in detail collectively later.

The making time in the making time column 136 represents a minute, an hour, and a date when the observation information is made.

In the observation information DB 64, there are as many records as the total number of tiles desired to be displayed throughout all patients. A record in a first line indicates that the “school doctor” in the “Meguro grade school” desires to display a tile including characters “physical condition—ordinary” on the health care screen 71 on the basis of a result of observing Kouhei Matsuda at 9 o'clock on Oct. 7, 2012. A record in a fourth line indicates that the “nursery attendant” in the “Meguro day nursery” desires to display a tile including characters “physical condition—good-humored” on the health care screen 71 on the basis of a result of observing Ayano Matsuda at 10 o'clock on Oct. 13, 2012.

### <<Detailed Description of Display Contents of Observation Information>>

The display contents may not be restricted to purely medical contents. It is also possible to set to display “memorial day note—picture book debut—on the 12th” which is an occurrence exhibiting the growth of “Ayano Matsuda” to parents of “Ayano Matsuda” in response to operation conducted by the “nursery attendant” in the “Meguro day nursery” (a record in an eighth line).

In addition, the display contents may be like a memorandum. For example, it is also possible to set to display “suckling memo—tap after giving” in response to operation conducted by the “nursery attendant” in the “Meguro day nursery” to urge the parent of “Ayano Matsuda” to suckle without fail after return home of “Ayano Matsuda” and touch the tile with a finger after suckling (a record in a sixth line). It is also possible to set to display “diaper memo—tap after changing” in response to operation conducted by the “nursery attendant” in the “Meguro day nursery” to urge the parent of “Ayano Matsuda” to change the diaper without fail after return home of “Ayano Matsuda” and then touch the tile with a finger (a record in a seventh line).

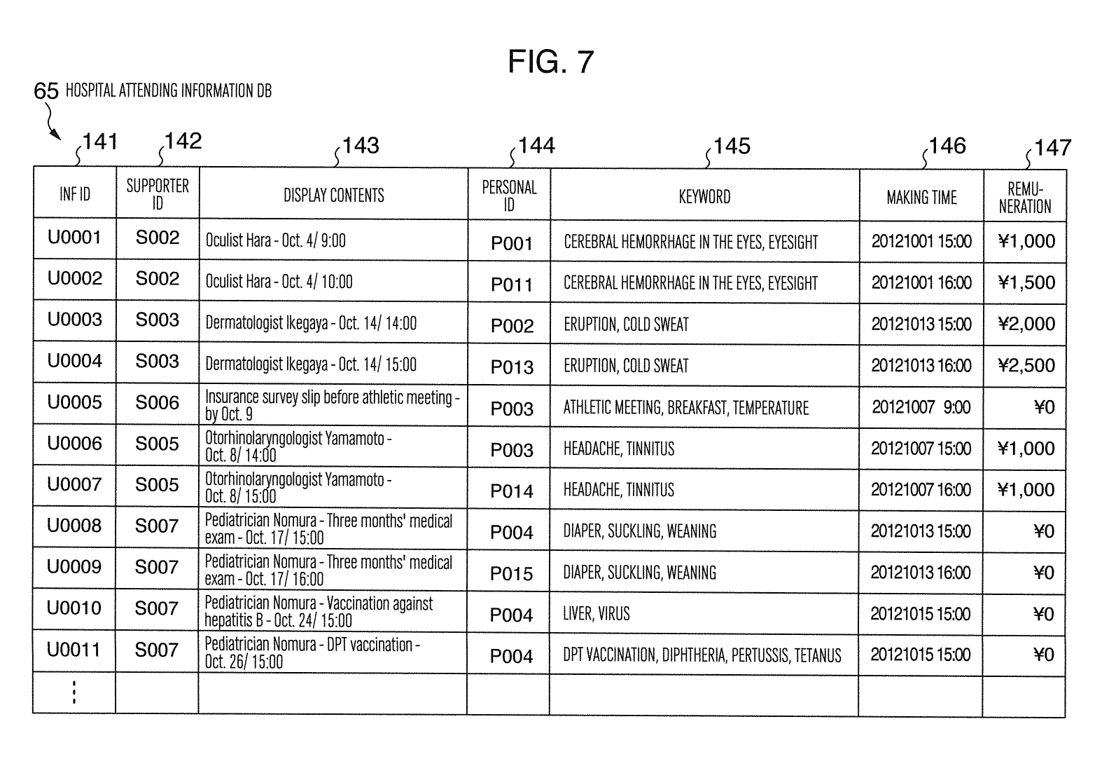

The hospital attending information DB 65 will now be described with reference to FIG. 7. In the hospital attending information DB 65, a supporter ID is stored in a supporter ID column 142 in association with an information ID stored in an information ID column 141. Display contents are stored in a display content column 143 in association with the information ID. A personal ID is stored in a personal ID column 144 in association with the information ID. Keywords are stored in a keyword column 145 in association with the information ID. A making time is stored in a making time column 146 in association with the information ID. A remuneration amount is stored in a remuneration column 147 in association with the information ID.

The information IDs in the information ID column 141 are the same as the information IDs shown in FIG. 5. Here, “U” in the information ID is an abbreviation of “upper,” and it means that a tile indicating the information is displayed in the line in the upper row of the health care screen 71. Here, “0001” or the like in the information ID is a unique numeral among information IDs having “U” as a prefix. In the present embodiment, “U” is assigned to the hospital attending information and the medicine taking information. And “0001 to 1000” are assigned to the hospital attending information, and “1001˜” are assigned to the medicine taking information. Information IDs having “U” as a prefix are referred to as U system information IDs sometimes.

Supporter IDs in the personal ID column 142 are the same as the supporter IDs shown in FIG. 4B.

The display contents in the display content column 143 are characters and the like displayed in the tiles as the hospital attending information.

The personal IDs in the personal ID column 144 are the same as the personal IDs shown in FIG. 4A.

The keywords in the keyword column 145 will be described in detail collectively later.

The making time in the making time column 146 represents a minute, an hour, and a date when the hospital attending information is made.

The remuneration amount in the remuneration column 147 is a scheduled amount (an amount borne by the health insurance may be excluded or included) of a doctor's fee and the like to be borne by a patient (or a parent of the patient) in relation to the hospital attending information.

In the hospital attending information DB 65, there are as many records as the number of tiles desired to be displayed throughout all patients. A record in a first line indicates the following facts.
A “general doctor” in “oculist Dr. Hara's office” made hospital attending information for “Ichiro Matsuda” at 15 o'clock on Oct. 1, 2012.
In the tile of the hospital attending information, “oculist Dr. Hara's office—9:00, October 14” (supporter name and reserved data) are displayed.
The scheduled amount to be paid by “Ichiro Matsuda” is “¥1,000.”
   A record in an eighth line indicates the following facts.
A “general doctor” in the “pediatrician Dr. Nomura's office” made hospital attending information for the parent of “Ayano Matsuda” at 15 o'clock on Oct. 13, 2012.
In the tile of the hospital attending information, “pediatrician Dr. Nomura's office three months' medical examinations October 17/15:00” (reserved date) is displayed.
The scheduled amount to be paid by the parent of “Ayano Matsuda” is “¥0.”

### <<Detailed Description of Display Contents of Hospital Attending Information>>

The display contents may not be restricted to attending a doctor's office. For example, it is also possible to set to display “insurance survey slip before athletic meeting—by October 9” to urge (the parent of) “Kouhei Matsuda” to submit a document to the “school doctor” in response to operation conducted by the “school doctor” in the “Meguro grade school” (a record in a fifth line).

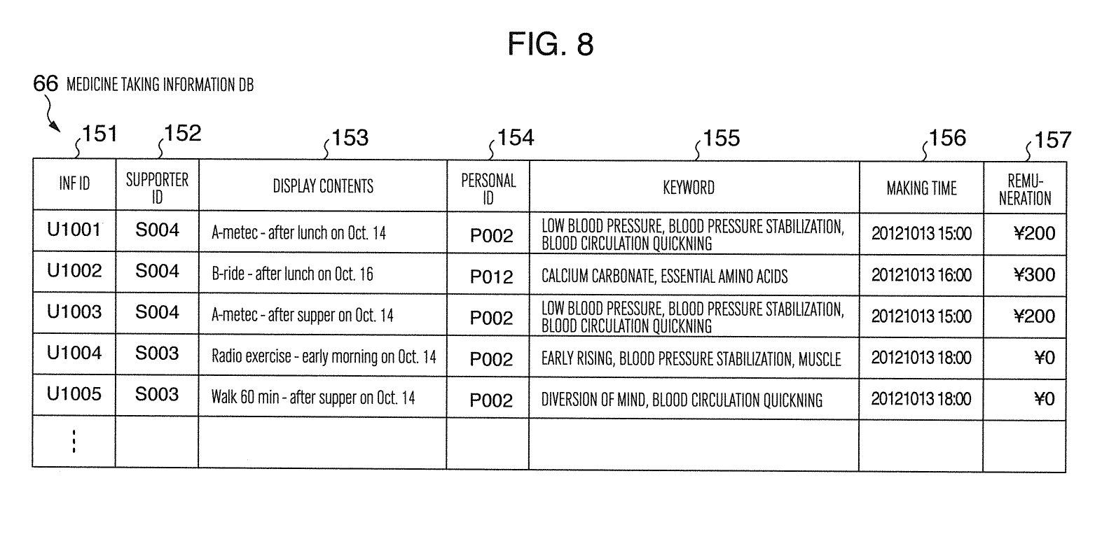

The medicine taking information DB 66 will now be described with reference to FIG. 8. In the medicine taking information DB 66, a supporter ID is stored in a supporter ID column 152 in association with an information ID stored in the information ID column 151. Display contents are stored in a display content column 153 in association with the information ID. A personal ID is stored in a personal ID column 154 in association with the information ID. Keywords are stored in a keyword column 155 in association with the information ID. A making time is stored in a making time column 156 in association with the information ID. A remuneration amount is stored in a remuneration column 157 in association with the information ID.

The information IDs in the information ID column 151 are the same as the information IDs shown in FIG. 5.

The supporter IDs in the supporter ID column 152 are the same as the supporter IDs shown in FIG. 4B.

The display contents in the display content column 153 are characters and the like displayed in the tiles as the medicine taking information.

The personal IDs in the personal ID column 154 are the same as the personal IDs shown in FIG. 4A.

The keywords in the keyword column 155 will be described in detail collectively later.

The making time in the making time column 156 represents a minute, an hour, and a date when the medicine taking information is made.

The remuneration amount in the remuneration column 157 is a scheduled amount of a charge of medicines and the like to be borne by a patient (or a parent of the patient) in relation to the medicine taking information.

In the medicine taking information DB 66, there are as many records as the number of tiles desired to be displayed throughout all patients. A record in a first line indicates the following facts.
A “pharmacist” in “Wakaba prescription filling drug store” made medicine taking information for the “Sachiko Matsuda” at 15 o'clock on Oct. 13, 2012.
In the tile of the medicine taking information, “A-metec—after lunch on October 14” (medicine name and taking timing) is displayed.
The scheduled amount to be paid by “Sachiko Matsuda” is “¥200.”

### <<Detailed Description of Display Contents of Medicine Taking Information>>

The display contents may not be restricted to a medicine name to be taken or the like. For example, it is also possible to set to display “radio exercise—early morning on October 14” to urge “Sachiko Matsuda” to take exercise in response to operation conducted by the “general doctor” in the “dermatologist Ikegaya” (a record in a fourth line).

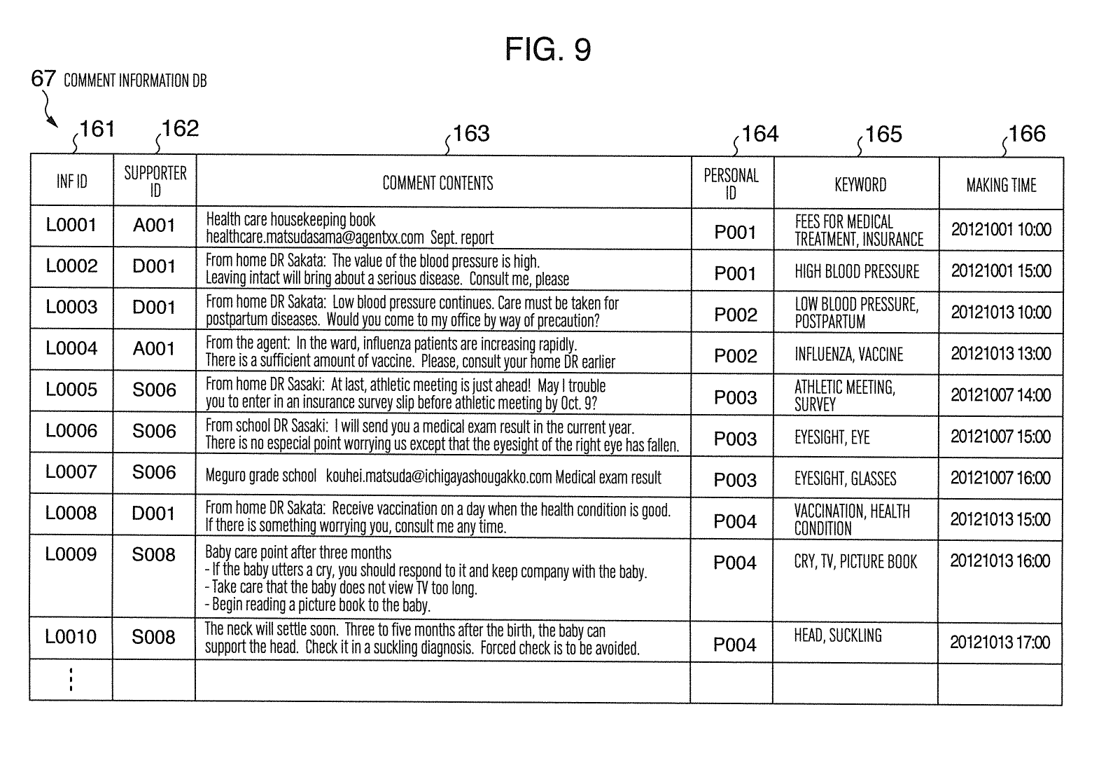

The comment information DB 67 will now be described with reference to FIG. 9. In the comment information DB 67, a supporter ID is stored in a supporter ID column 162 in association with an information ID stored in the information ID column 161. Comment contents are stored in a comment content column 163 in association with the information ID. A personal ID is stored in a personal ID column 164 in association with the information ID. Keywords are stored in a keyword column 165 in association with the information ID. A making time is stored in a making time column 166 in association with the information ID.

The information IDs in the information ID column 161 are the same as the information IDs shown in FIG. 5. Here, “L” in the information ID is an abbreviation of “lower,” and it means that a tile indicating the information is displayed in the line in the lower row of the health care screen 71. Here, “0001” or the like in the information ID is a unique numeral among information IDs having “L” as a prefix. In the present embodiment, however, “L” is assigned only to the comment information. Information IDs having “L” as a prefix are referred to as L system information IDs sometimes.

Supporter IDs in the personal ID column 162 are the same as the supporter IDs shown in FIG. 4B.

The comment contents in the comment content column 163 are characters and the like displayed in the tiles as the comment information. In the ordinary case, the comment contents are not a word, but a composition having some length. If the composition is long, however, the comment contents may be a combination of a title of the composition and information (link information) indicating the location of the composition (first and seventh lines).

The personal IDs in the personal ID column 164 are the same as the personal IDs shown in FIG. 4A.

The keywords in the keyword column 165 will be described in detail collectively later.

The making time in the making time column 166 represents a minute, an hour, and a date when the comment information is made.

In the comment information DB 67, there are as many records as the number of tiles desired to be displayed throughout all patients. In other words, in the case where the same comment contents are displayed for a plurality of patients, there are as many records having the comment contents as the number of patients.

By the way, a record in a second line indicates the following facts.
A “home doctor” made comment information for “Ichiro Matsuda” at 15 o'clock on Oct. 1, 2012.
In the tile of the comment information, “From home doctor Sakata: The value of the blood pressure is high. Leaving intact will bring about a serious disease. Consult me, please” is displayed.

### <<Association Among Schedule Information, Biological System Information, and Comment Information>>

Hereafter, association among schedule information, biological system information, and comment information (individual information) will be described. At the same time, the role of the “keyword” will also be described. By the way, keywords are words (feature words) which represent features of the information directly.

With reference to FIG. 12, processing executed by the associating unit 52 in the agent terminal device 5 in order to associate, for example, 211e “A-metec after lunch on 14th,” 212f “the lowest blood pressure 70 mmHg,” and 213a “From home doctor Sakata: Low blood pressure continues. - - - ” with each other is as follows.

(1) The associating unit 52 acquires one or a plurality of keywords from “A-metec after lunch on 14th.” Various methods for acquiring keywords are conceivable. The simplest method is a method of accepting a character string or voice such as “low blood pressure” which is input as a keyword itself by the supporter via the input device 12 such as the keyboard or the microphone 19. The associating unit 52 may acquire one or a plurality of keywords from the character string “A-metec after lunch on 14th” by using a known method. The number of words in “A-metec after lunch on 14th” is as small as six, and consequently a significant keyword is not acquired in some cases. Therefore, the associating unit 52 uses “A-metec” as a search key and acquires a composition which describes its effect and the like from an external database (such as a home page of a pharmaceutical corporation) via the Internet. And the associating unit 52 may acquire one or a plurality of keywords from the acquired composition by using the known method. There is, for example, the TF-IDF method as the “known method.”

(2) The associating unit 52 acquires one or a plurality of keywords from “the lowest blood pressure 70 mmHg.” The associating unit 52 may accept characters (voice) input by the supporter as the keyword itself as described above, or may acquire one or a plurality of keywords from the character string “the lowest blood pressure 70 mmHg” by using the known method. In addition, the associating unit 52 uses “the lowest blood pressure” as a search key, and acquires a composition describing symptoms from an external database (such as medical books) via the Internet. And the associating unit 52 may acquire one or a plurality of keywords from the acquired composition by using the known method. In addition, the associating unit 52 may acquire synonyms of the “lowest blood pressure” from an external dictionary as keywords.

(3) The associating unit 52 acquires one or a plurality of keywords from “From home doctor Sakata: Low blood pressure continues. - - - .” The comment contents have a composition which is sufficient in length. Therefore, the associating unit 52 acquires one or a plurality of keywords out of “From home doctor Sakata: Low blood pressure continues. - - - ” by using the known method. If the comment contents don't have a sufficient length, the associating unit 52 uses an arbitrary character string included in the comment contents as a search key and acquires a composition including the character string from an external database via the Internet. And the associating unit 52 may acquire one or a plurality of keywords from the acquired composition by using the known method.

(4) In this way, the associating unit 52 acquires keywords as regards all schedule information, biological system information, and comment information, and stores the keywords in association with the information IDs. The keywords are nothing but the keywords stored in FIGS. 5 to 9.

(5) The associating unit 52 compares the keywords with each other, and matches (associates) keywords which coincide with each other or which are like. For example, the associating unit 52 uses a keyword “metabolic” associated with “M0001” or its synonym as a search key and searches keywords associated with all U system information IDs. And the associating unit 52 acquires U system information IDs associated with pertinent keywords. In addition, the associating unit 52 uses “metabolic” or its synonym as a search key and searches keywords associated with all L system information IDs. And the associating unit 52 acquires L system information IDs associated with pertinent keywords. And the associating unit 52 associates “M0001” and the acquired U system information IDs and L system information IDs with each other and stores them.

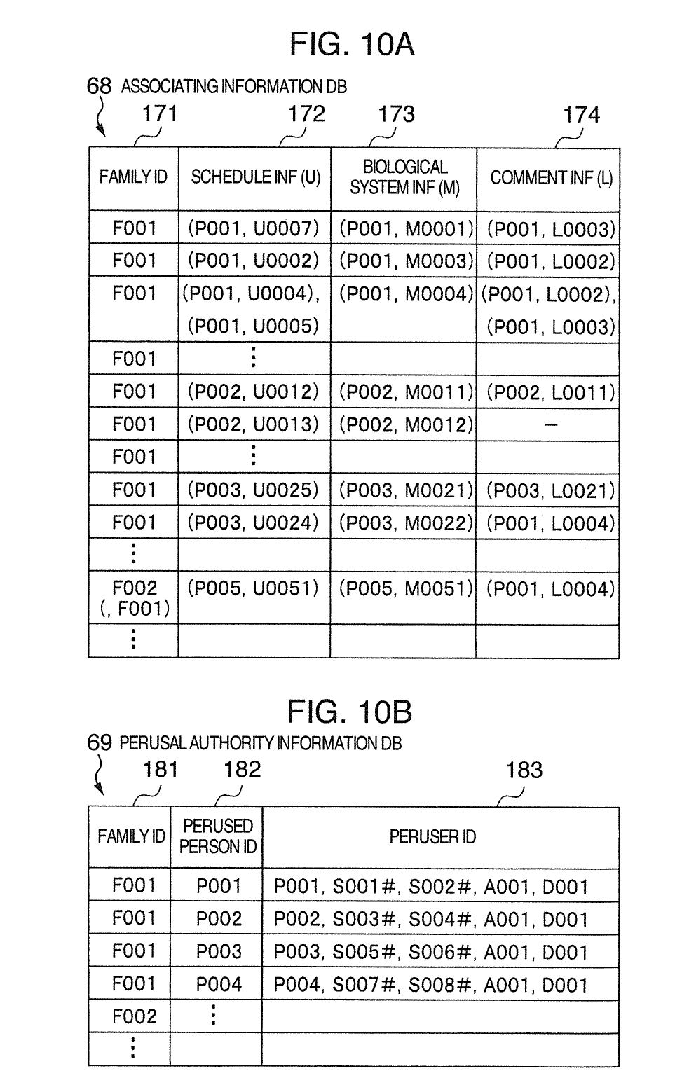

(6) The associating unit 52 repeats the processing of (5) for all biological system information “M0001, M0002, - - - M1001, M1002, - - - .” As a result of such processing, the associating information DB 68 shown in FIG. 10A is made. (Details thereof will be described hereafter).

The associating information DB 68 will now be described with reference to FIG. 10A. In the associating information DB 68, a U system information vector is stored in a schedule information (U) column 172 in association with a family ID stored in a family ID column 171. An M system information vector is stored in a biological system information (M) column 173 in association with the family ID. An L system information vector is stored in a comment information (L) column 174 in association with the family ID.

The family IDs in the family ID column 171 are the same as the family IDs shown in FIG. 4A.

A U system information vector in the schedule information (U) column 172 is a combination of a personal ID and a U system information ID. Here, information composed of two elements such as “(personal ID, information ID)” is referred to as “information vector.” And an information vector having a U(M, L) system information ID as the second element is referred to as (M, L) system information vector.

The M system information vector in the biological system information (M) column 173 is a combination of a personal ID and an M system information ID.

The L system information vector in the comment information (L) column 174 is a combination of a personal ID and an L system information ID.

The health care screen 71 (FIG. 16) is a screen concerning the patient “Ichiro Matsuda” having a family ID “F001” and a personal ID “P001.” A tile “U0002” in the line in the upper row, a tile “M0003” in the line in the middle row, and a tile “L0002” in the line in the lower row are displayed with emphasis and coupled by thick lines. A record in a second line in the associating information DB 68 (FIG. 10A) represents association of these three tiles.

The health care screen 71 (FIG. 18) is also a screen concerning the patient “Ichiro Matsuda.” Tiles “U0004” and “U005” in the line in the upper row, a tile “M0004” in the line in the middle row, and tiles “L0002” and “L0003” in the line in the lower row are displayed with emphasis, and coupled by thick lines. A record in a third line in the associating information DB 68 (FIG. 10A) represents association of these five tiles. For convenience of description, it is supposed that concrete information IDs such as “U0001” do not correspond to information IDs in FIGS. 5 to 9.

### <<Features of Association>>

Features of such association of information vectors are as follows.
In principle, a record in the associating information DB 68 is made for all M system information vectors.
Exceptionally, it may be allowed not to make a record for a certain M system information vector. For example, there is no record which stores (P001, M0002) between a first line and the second line in FIG. 10A. This means that there is no U system information vector which matches “(P001, M0002)” and there is no L system information vector which matches “(P001, M0002)”, either as a result of the matching.
In principle, one or a plurality of U system information vectors and one or a plurality of L system information vectors are associated with one M system information vector.
Exceptionally, it may be allowed that the number of associated U system information vectors or L system information vectors is “0” (a record in a sixth line in FIG. 10A).
In principle, a U system information vector, an M system information vector, and an L system information vector share the same personal ID.
Exceptionally, it may be allowed that information vectors having different personal IDs are associated with each other (a record in a ninth line in FIG. 10A). For example, comment information “refrain from smoking” concerning “Ichiro Matsuda” may be associated with schedule information “gargling after his return home every day” and biological system information “have a frequent cough” concerning “Kouhei Matsuda.”
In principle, personal IDs included in a U system information vector, an M system information vector, and an L system information vector which are associated with each other correspond to the same family ID.
Exceptionally, it may be allowed that personal IDs included in a U system information vector, an M system information vector, and an L system information vector which are associated with each other correspond to a plurality of different family IDs (a record in an eleventh line in FIG. 10A). For example, in the case where “Ken Eguchi” and “Ichiro Matsuda” work in the same place of work, the comment information “refrain from smoking” concerning “Ichiro Matsuda” may be associated with schedule information “wear a mask every day” and biological system information “have a frequent cough” concerning “Ken Eguchi.”

In the above-described matching, the associating unit 52 uses a feature word concerning the M system information ID as reference and searches for a feature word concerning the U system information ID and a feature word concerning the L system information ID. However, the associating unit 52 may use a feature word concerning the U system (L system) information ID as reference and searches for a feature word concerning the M system information ID and a feature word concerning the L system (U system) information ID.

The perusal authority information DB 69 will now be described with reference to FIG. 10B. In the perusal authority information DB 69, a perused person ID is stored in a perused person ID column 182 in association with a family ID stored in a family ID column 181. A peruser ID is stored in a peruser ID column 183 in association with the family ID.

The family IDs in the family ID column 181 are the same as the family IDs shown in FIG. 4A.

The perused person ID in the perused person ID column 182 is a personal ID of a patient whose tile can be perused.

The peruser ID in the peruser ID column 183 is a personal ID, a supporter ID, an agent ID or a home doctor ID of a person (a patient, a supporter, an agent or a home doctor) who can peruse the tile.

By the way, those who can peruse a tile concerning “Ichiro Matsui” are “Ichiro Matsui” himself, an industrial doctor “S001,” a general doctor “S002,” an agent “A001,” and a home doctor “D001” (a record in a first line in FIG. 10B). In some cases, there are a plurality of supporters, such as the industrial doctor “S001” and the general doctor “S002,” for one patient. At this time, it is desirable from the viewpoint of management of personal information in some cases to place restrictions to prevent a supporter from perusing a tile concerning information made (acquired) by another supporter. On the other hand, an agent and a home doctor are designated on the assumption that such restrictions are not placed. In the record in the first line, “#” attached to “S001” and “S002” indicates that the supporter cannot peruse a tile concerning information made (acquired) by another supporter.

In the perusal authority information DB 69, there are as many records as the number of perused person IDs. In other words, for each patient, one or a plurality of persons who can peruse tiles concerning the patient are identified. More finely, however, persons who can peruse tiles every information vector may be identified (not illustrated).

In principle, a patient can peruse only tiles concerning other patients who belong to the same family. Exceptionally, a certain patient may also be allowed to peruse tiles concerning a patient who belongs to another family. Because there are human fiduciary relations such as, for example, de facto marriage and adult guardianship which exceed legal family relations.

### <<General Processing Procedure>>

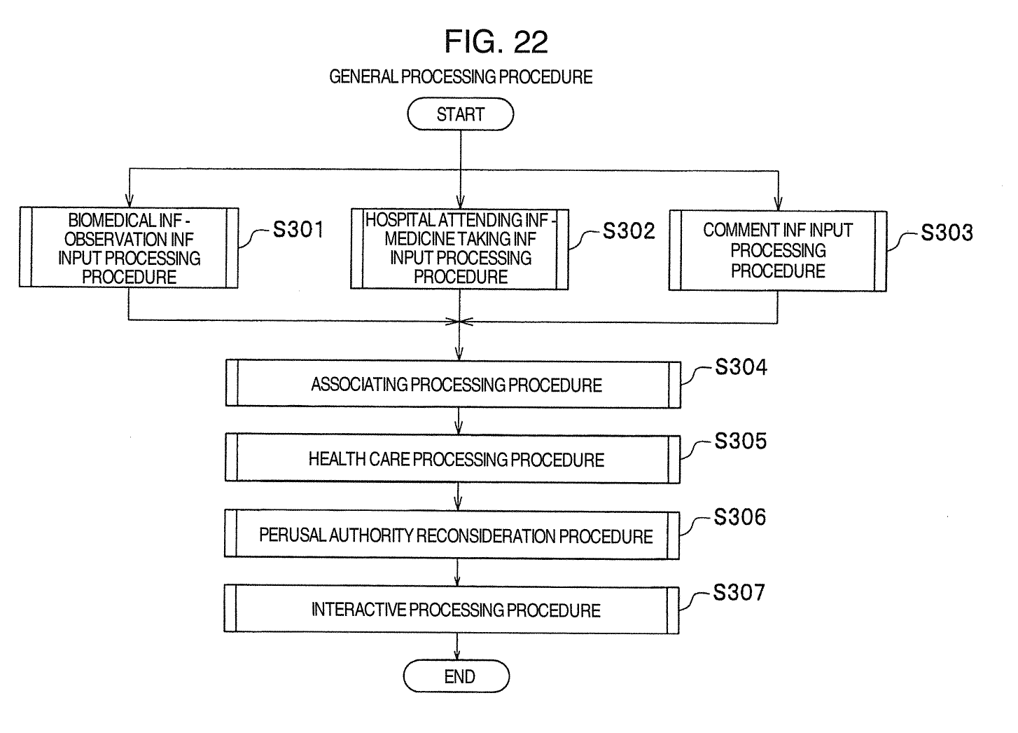

A general processing procedure will now be described with reference to FIG. 22. As a premise for starting the general processing procedure, it is supposed that the family information DB 61 (FIG. 4A) and the supporter information DB 62 (FIG. 4B) are already completed and stored in the auxiliary storage device 35 in the agent terminal device 5. In addition, it is supposed that the perusal authority information DB 69 (FIG. 10B) with predetermined initial values stored in the peruser ID column 183 is stored in the auxiliary storage device 35 in the agent terminal device 5.

At step S301, the patient terminal device 2 or the supporter terminal device 3 executes a biomedical information—observation information input processing procedure.

At step S302, the supporter terminal device 3 executes a hospital attending information—medicine taking information input processing procedure.

At step S303, the supporter terminal device 3, the home doctor terminal device 4 or the agent terminal device 5 executes a comment information input processing procedure.

At a stage in which the three steps described above are finished, the biological information DB 63 (FIG. 5), the observation information DB 64 (FIG. 6), the hospital attending information DB 65 (FIG. 7), the medicine taking information DB 66 (FIG. 8), and the comment information DB 67 (FIG. 9) are completed and stored in the auxiliary storage device 35 in the agent terminal device 5.

At step S304, the agent terminal device 5 executes an associating processing procedure. At a stage in which the step is finished, the associating information DB 68 (FIG. 10A) is completed and stored in the auxiliary storage device 35 in the agent terminal device 3. And preparations for conducting exchanges concerning health guidance between a patient and a supporter or the like are ready.

At step S305, the agent terminal device 5 executes a health care processing procedure. At the step, the patient peruses the health care screen 71. The agent terminal device 5 executes processing of displaying a tile with emphasis or the like in response to an input operation of the patient.

At step S306, the agent terminal device 5 executes a perusal authority reconsideration procedure. At the step, the agent terminal device 5 updates the perusal authority information DB 69 in response to an input operation of the patient.

At step S307, the agent terminal device 5 executes an interactive processing procedure. At the step, real time communication using an image and a voice is implemented between the patient and the supporter. Thereafter, the general processing procedure is finished.

Hereafter, the above-described steps in the general processing will be described in more detail.

### <<Biological Information—Observation Information Input Processing Procedure>>

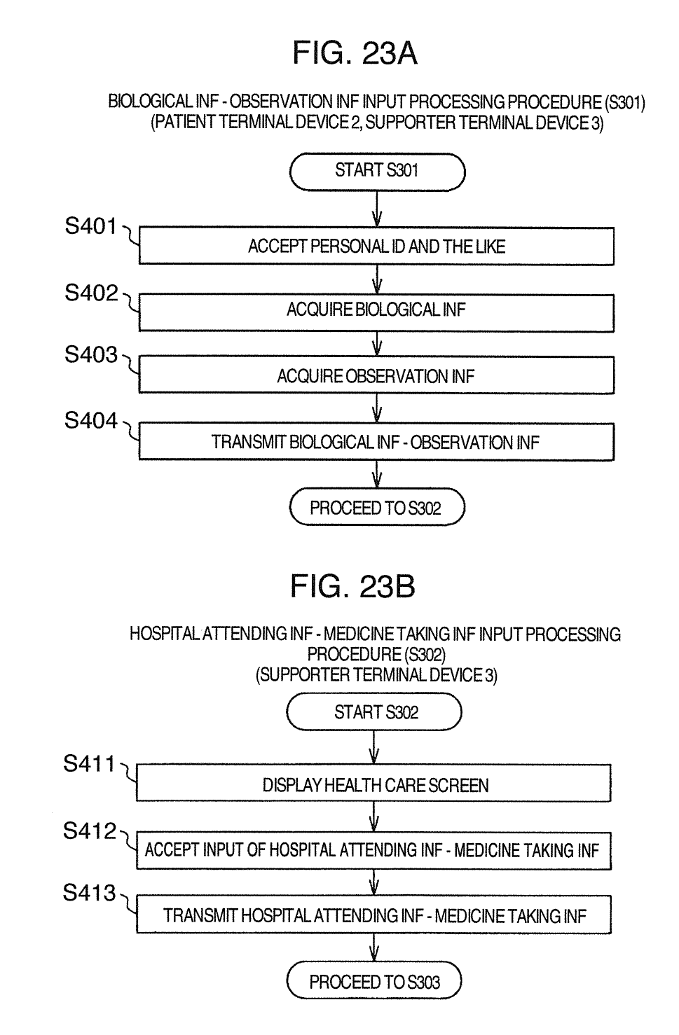

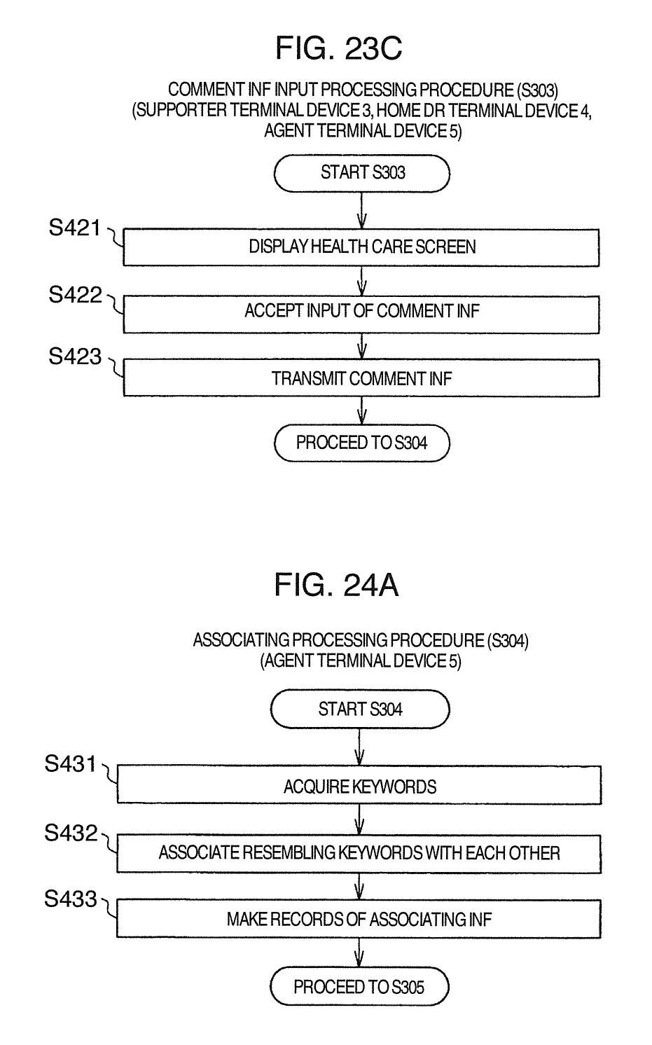

The biological information—observation information input processing procedure will now be described with reference to FIG. 23A. The biological information—observation information input processing procedure is details of the step S301 in the general processing procedure. In the ensuing description, description is made sometimes with a distinction between a case (case 1) where a patient inputs biological information of himself or herself and a case (case 2) where a supporter or a home doctor inputs biological information/observation information of a patient (such as a schoolboy or a suckling). If a distinction is not made between them, the description is common to both of them. And in the case 1, the operation subject is the transmission/reception information manger 21 in the patient terminal device 2. In the case 2, the operation subject is the transmission/reception information manger 21 in the supporter terminal device 3 or the home doctor terminal device 4.

At step S401, the transmission/reception information manager 21 in the patient terminal device 2 or the like accepts a personal ID and the like. Specifically, in the case 1, the transmission/reception information manager 21 accepts a personal ID of a patient and an acquirer ID which is input by the patient or the like via the keyboard (the input device 12). In the case 2, the transmission/reception information manager 21 accepts a personal ID of a patient obtained when a supporter or the like passes a card storing the personal ID of the patient through a card reader (the input device 12) and a supporter ID which is input by the supporter or the like via the keyboard. A parent of the patient or the like stores the personal ID of the patient on the card and places the card in custody of the supporter or the like beforehand.

At step S402, the transmission/reception information manager 21 acquires biological information. Specifically, the transmission/reception information manager 21 acquires a biological information category, a value of biological information, and an acquisition time (current time) from the biological information sensor 18 (such as the electronic sphygmomanometer, the electronic thermometer, or the electronic scale) which is in contact with a part of a living body of the patient.

The transmission/reception information manager 21 may accept sleeping hours of the patient which is input by the patient, supporter or the like via the keyboard. The display screen manager 22 may display an icon which indicates a food such as “a bowl of rice,” “an egg,” “a slice of bread,” or “100 ml. of milk” on the output device 13 and accept tapping of the icon conducted by the patient or supporter repetitively a number of times corresponding to a quantity eaten by the patient. The transmission/reception information manager 21 may store information which associates a food with a calorific power value such as, for example, “a bowl of rice=100 kcal” in the auxiliary storage device 15, and acquire a product of the calorific power value and the number of times of tapping as caloric intake. In addition, the transmission/reception information manager 21 may acquire a value (percent) obtained by dividing the number of steps of the patient, which is acquired by a pedometer (the biological information sensor 18), by a reference value as an exercise goal attaining rate. Here, the reference value is an exercise goal value ordered by the supporter.

At step S403, the transmission/reception information manager 21 acquires observation information. Specifically, in the case 1, the transmission/reception information manager 21 accepts display contents such as “physical condition—ordinary” which are input by the patient via the keyboard, and acquires making time. In the case 2, the transmission/reception information manager 21 accepts display contents concerning the patient such as “physical condition—ordinary” which are input by a supporter or the like who is observing the patient via the keyboard (the input device 12), and acquires making time.

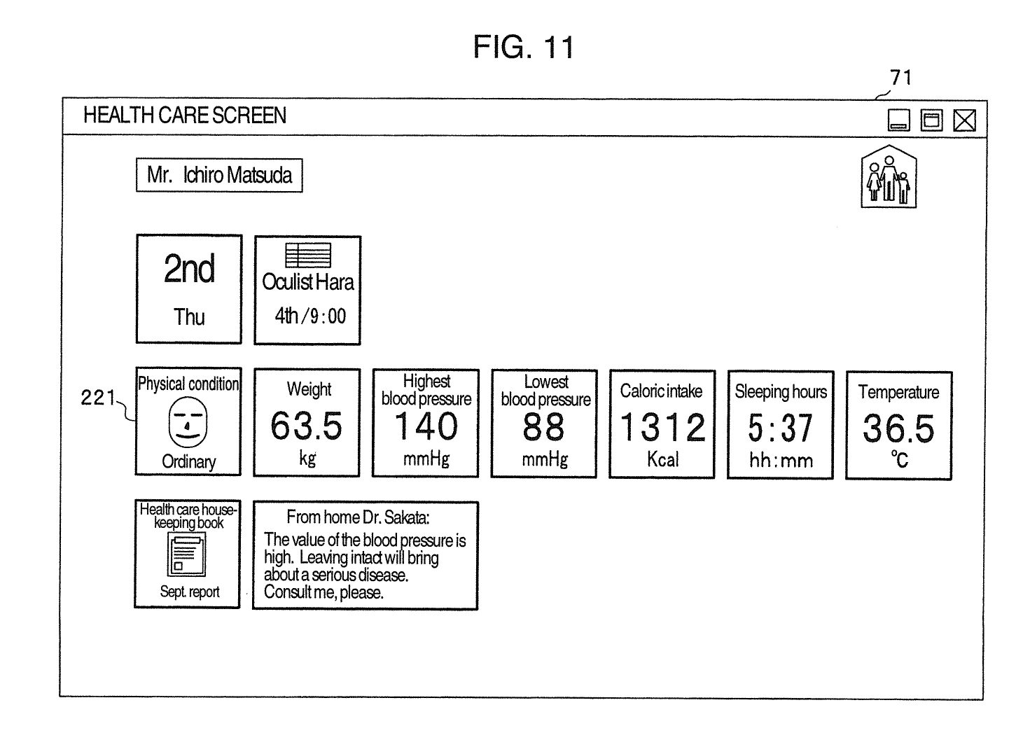

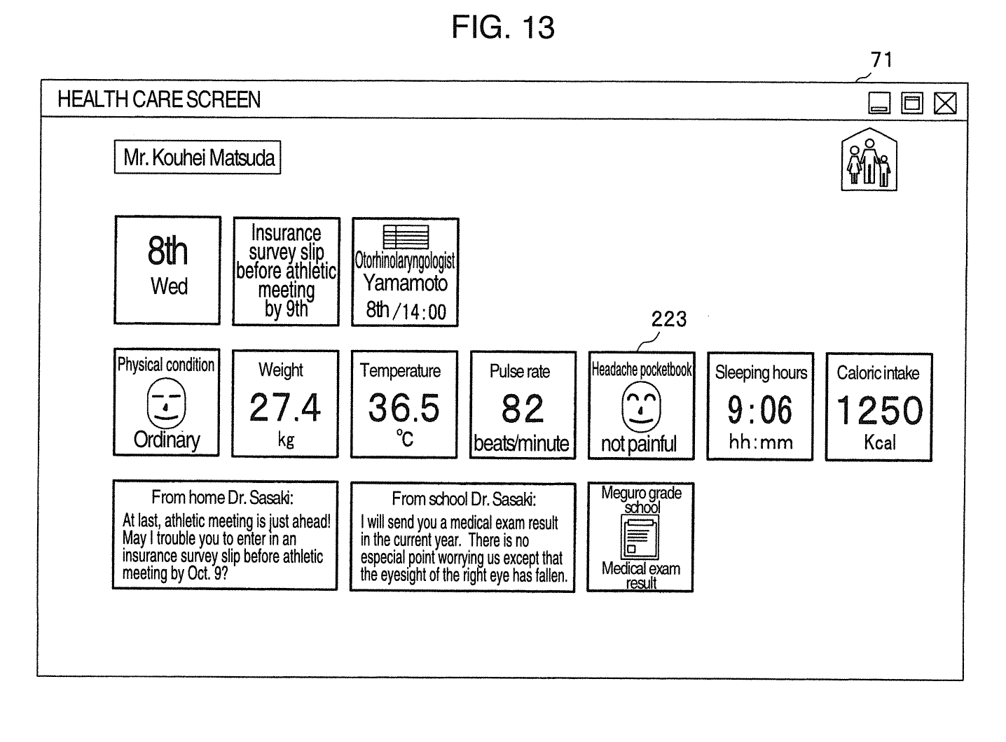

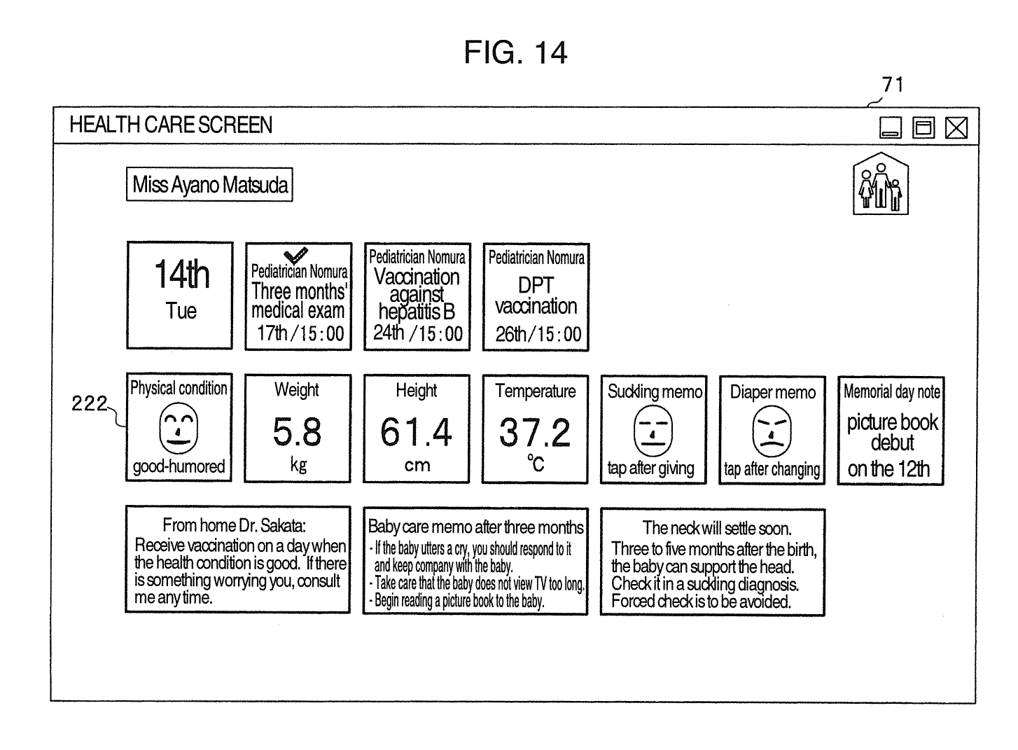

In the case 1 or case 2, the patient, supporter or the like may use a touch panel instead of the keyboard. The display screen manager 22 may display an icon (tile) made to imitate a human face on the touch panel. The icon may have “ordinary” (reference numeral 221 in FIG. 11) as reference (an initial value), change to “good-humored” (reference numeral 222 in FIG. 14) by tapping (touching lightly with a finger) a right cheek, and change to “very good” (reference numeral 212a in FIG. 12) by further tapping the right cheek. Furthermore, the icon may have “ordinary” as reference, change to “ill-humored” by tapping a left cheek, and change to “very bad” by further tapping the left cheek (not illustrated). And the transmission/reception information manager 21 accepts information which is input by the patient or the like in this way, as observation information. The same is true of a “headache pocketbook” 223 shown in FIG. 13 (not painful tap right cheek→slightly painful→further tap right cheek→very painful).

At step S404, the transmission/reception information manager 21 transmits the biological information—observation information. Specifically, the transmission/reception information manager 21 transmits the personal ID, the acquirer ID and the supporter ID accepted at the step S401, the biological information category, the biological information value and the acquisition time acquired at the step S402, and the display contents and the making time acquired at the step S403 to the agent terminal device 5. Thereupon, the transmission/reception information manager 51 in the agent terminal device 5 assigns a number to the information ID, and makes new records of the biological information DB 63 (FIG. 5) and the observation information DB 64 (FIG. 6) on the basis of the numbered information ID and received information. At this time, the transmission/reception information manager 51 leaves the keyword column 125, the weight column 128 and the warning column 129 (shown in FIG. 5) and the keyword column 135 (shown in FIG. 6) blank. Thereafter, processing proceeds to the step S302 in the general processing procedure.

### <<Hospital Attending Information—Medicine Taking Information Input Processing Procedure>>

The hospital attending information—medicine taking information input processing procedure will now be described with reference to FIG. 23B. The hospital attending information—medicine taking information input processing procedure is details of the step S302 in the general processing procedure.

At step S411, the display screen manager 22 in the supporter terminal device 3 displays the health care screen 71 (FIG. 11 or the like). Specifically, the transmission/reception information manager 21 accepts a personal ID of an object patient which is input by a supporter via the keyboard. And the transmission/reception information manager 21 transmits the accepted personal ID to the agent terminal 5.

Thereupon, the display screen manager 54 in the agent terminal device 5 searches the biological information DB 63 (FIG. 5) and the observation information DB 64 (FIG. 6) by using the accepted personal ID as a search key, acquires pertinent records, and makes the health care screen 71 (FIG. 11 or the like) on the basis of the acquired records. At this time, the display screen manager 54 may execute narrowing down, such as, for example, acquiring a predetermined number of records having newer acquisition times every biological information category. The screen displays tiles in the middle row. And the display screen manager 54 transmits the made health care screen 71 to the supporter terminal device 2. The display screen manger 22 in the supporter terminal device 3 displays the received health care screen 71 on the output device 13. At this stage, the supporter can look through the biological system information of the patient in a time series.

At step S412, the transmission/reception information manger 21 in the supporter terminal device 3 accepts input of hospital attending information—medicine taking information. Specifically, the transmission/reception information manger 21 accepts display contents, such as “dermatologist Dr. Ikegaya's office—October 14/14:00” and “A-metec after lunch on October 14,” and a remuneration amount which are input by the supporter via the keyboard, and acquires making time. At this time, the supporter can make schedule information concerning hospital attending/medicine taking of the patient while looking through the biological system information of the object patient.

At step S413, the transmission/reception information manager 21 transmits the hospital attending information—medicine taking information. Specifically, the transmission/reception information manager 21 transmits the personal ID accepted at the step S411 and the display contents, the remuneration amount and the making time acquired at the step S412 to the agent terminal device 5 together with the supporter ID. Thereupon, the transmission/reception information manager 51 in the agent terminal device 5 assigns a number to the information ID, and makes new records of the hospital attending information DB 65 (FIG. 7) and the medicine taking information DB 66 (FIG. 8) on the basis of the numbered information ID and received information. At this time, the transmission/reception information manager 51 leaves the keyword column 145 (FIG. 7) and the keyword column 155 (FIG. 8) blank. Thereafter, processing proceeds to the step S303 in the general processing procedure.

### <<Comment Information Input Processing Procedure>>

The comment information input processing procedure will now be described with reference to FIG. 23C. The comment information input processing procedure is details of the step S303 in the general processing procedure.

At step S421, the display screen manager 22 in the supporter terminal device 3 or the home doctor terminal device 4 or the display screen manager 54 in the agent terminal device 5 displays the health care screen (FIG. 11 or the like). Processing at the step S421 is similar to the processing at the hospital attending information—medicine taking information input processing procedure step S411. In the case where the agent uses the agent terminal device 5, however, it is a matter of course that the exchange of information between terminal devices as described above is not executed, but the processing is completed within the agent terminal device 5. At this stage, the supporter or the like can look through the biological system information of the patient in a time series.

At step S422, the display screen manger 22 or 54 accepts input of comment information. Specifically, the display screen manger 22 or 54 accepts comment contents such as “From home doctor Sakata: Low blood pressure continues. Care must be taken for a postpartum disease, - - - ” which are input by the supporter or the like via the keyboard, and acquires making time. At this time, the supporter or the like can make an expression of an advice to be given to the patient while looking through the biological system information of the object patient. By the way, the display screen manger 22 or 54 may accept comment contents (voice waves) which are input by the supporter or the like via the microphone 19/38 and convert the voice waves to character information by using a known technique.

At step S423, the transmission/reception information manager 21 or 51 transmits comment information. Specifically, the transmission/reception information manager 21 or 51 transmits the personal ID accepted at the step S421, and the comment contents and the making time acquired at the step S422 to the agent terminal device 5 together with the supporter ID (the home doctor ID or the agent ID). By the way, transmission is not necessary in the case where the agent uses the agent terminal device 5 as described above. Thereupon, the transmission/reception information manager 51 in the agent terminal device 5 assigns a number to the information ID, and makes new records of the comment information DB 67 (FIG. 9) on the basis of the numbered information ID and received information. At this time, the transmission/reception information manager 51 leaves the keyword column 165 blank. Thereafter, processing proceeds to the step S304 in the general processing procedure.

### <<Order of the Steps S301 to S303>>

In principle, as for the processing at the step S301, a patient himself or herself conducts inputting concerning the patient. A supporter conducts inputting concerning the patient. Another supporter conducts inputting concerning the patient. - - - In this way, inputting is repeated a plurality of times. In addition, the inputting is repeated for all patients. As for the processing at the step S302 and S303, one supporter, agent or home doctor conducts the processing for one or a plurality of patients collectively. And the processing is executed repetitively for all supporters or the like. The processing order of the steps S301 to S303 is not restricted, but they may be executed in parallel at the same time. From the viewpoint that the supporter or the like can peruse the biological system information, however, it is desirable that the processing at the step S301 is already executed when executing the processing at the steps S302 and S303.

### <<Associating Processing Procedure>>

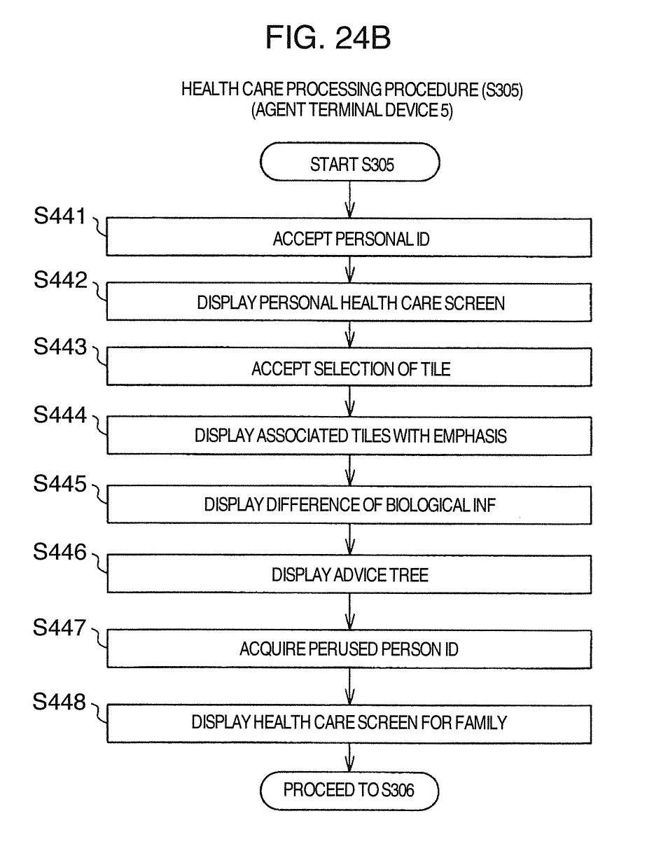

The associating processing procedure will now be described with reference to FIG. 24A. The associating processing procedure is details of the step S304 in the general processing procedure.

At step S431, the associating unit 52 in the agent e nal device 5 acquires keywords. Specifically, first, the associating unit 52 acquires an arbitrary unprocessed record from an arbitrary DB included in the biological information DB 63 (FIG. 5), the observation information DB 64 (FIG. 6), the hospital attending information DB 65 (FIG. 7), the medicine taking information DB 66 (FIG. 8) and the comment information DB 67 (FIG. 9).

Secondly, the associating unit 52 acquires keywords (feature words) for the biological information category, display contents, or comment contents in the acquired record. The way of acquiring the keywords has been described above, and consequently it is not repeated.

Thirdly, the associating unit 52 stores one or a plurality of acquired keywords in the keyword columns 125, 135, 145, 155 and 165 (FIGS. 5 to 9) of the acquired record. The associating unit 52 repeats these kinds of processing until unprocessed records disappear in all of the DBs 63 to 67.

At step S432, the associating unit 52 associates resembling keywords with each other.

At step S433, the associating unit 52 makes records in the associating information DB 68 (FIG. 10A). How to associate (match) keywords with each other and how to make records in the associating information DB 68 (features of associating) have been described earlier, and consequently they are not repeated. Thereafter, the processing proceeds to the step S305 in the general processing procedure.

### <<Health Care Processing Procedure>>

The health care processing procedure will now be described with reference to FIG. 24B. The health care processing procedure is details of the step S305 in the general processing procedure. As a premise for starting the health care processing procedure, it is now supposed that communication is already established between the patient terminal device 2 (or the supporter terminal device 3) and the agent terminal device 5.

At step S441, the transmission/reception information manager 51 in the agent terminal device 5 accepts a personal ID. Specifically, the transmission/reception information manager 51 accepts a personal ID from the patient terminal device 2. The personal ID may be a personal ID of a patient which is input by the patient himself or herself via the keyboard in the patient terminal device 2. The personal ID may be a personal ID of a patient which is read from the card by a card reader in the supporter terminal device 3.

At step S442, the display screen manger 54 in the agent terminal device 5 displays the personal health care screen 71. Specifically, first, the display screen manger 54 searches the biological information DB 63 (FIG. 5) and the observation information DB 64 (FIG. 6) by using the personal ID accepted at the step S441 as a search key, and acquires pertinent records. The information IDs stored in the acquired records are M system information IDs. By the way, at this time, the display screen manger 54 may narrow down pertinent records, for example, as described hereafter and acquire resultant records.
Records having an old acquisition (making) time which precedes the current time taken as reference by at least a predetermined time are not acquired.
From among records having the same biological information category, records which don't exceed in number a predetermined number are acquired in order of acquisition time, beginning with the newest.

Secondly, the display screen manager 54 searches the hospital attending information DB 65 (FIG. 7) and the medicine taking information DB 66 (FIG. 8) b_{y} using the personal ID accepted at the step S441, and acquires pertinent records. The information ID stored in the acquired records is the U system information ID. By the way, at this time, the display screen manger 54 may narrow down pertinent records, for example, as described hereafter and acquire resultant records.
Records having an old making time which precedes the current time taken as reference by at least a predetermined time are not acquired.
Records having an old date and hour which precedes the current time taken as reference by at least a predetermined time as display contents are not acquired. For example, hospital attending and medicine taking schedules in the past are not acquired.
Records having a date and hour which is later than the current time taken as reference by at least a predetermined time as display contents are not acquired. For example, schedules after half a year are not acquired because there isn't the sense for the real.

Thirdly, the display screen manager 54 searches the comment information DB 67 (FIG. 9) by using the personal ID accepted at the step S441 as a search key, and acquires pertinent records. The information ID stored in the acquired records is an L system information ID. By the way, at this time, the display screen manger 54 may narrow down pertinent records, for example, as described hereafter and acquire resultant records.
Records having an old making time which precedes the current time taken as reference by at least a predetermined time are not acquired.

Records in the biological information DB 63 and the like acquired after the narrowing down in the first to third processing at the step S442 are referred to as “display object records” sometimes.

Fourthly, the display screen manager 54 makes the health care screen 71. Specifically, the display screen manager 54 makes the health care screen 71 (for example, FIG. 12) concerning a patient identified by the personal ID which is accepted at the step S441. For example, supposing that the personal ID accepted at the step S441 is “P002,” description will be continued hereafter. In this case, processing conducted by the display screen manager 54 to make the health care screen shown in FIG. 12 is as follows.
The family information DB 61 (FIG. 4A) is searched by using the personal ID “P002” in the display object records as a search key. A family name “Sachiko Matsuda” in the pertinent records is disposed in a patient full name column 204.
A family icon 205 is disposed in an arbitrary place.
A tile 211a describing the current date and hour and day of the week is disposed in the leftmost position of the upper row 201. The year and month may be omitted in the date and hour (the same is true of other tiles as well).
Tiles describing display contents of records having a U system information ID among the acquired display object records are arranged in one line in the upper row 201 from the left to the right in order of time included in the display contents, beginning with the earliest (reference characters 211b to 211f).
Tiles describing a biological information value or display contents of records having an M system information ID among the acquired display object records are arranged in one line in the middle row 202 from the left to the right in order of acquisition time or making time, beginning with the earliest (reference characters 212a to 212g).
Tiles describing comment contents of records having an L system information ID among the acquired display object records are arranged in one line in the lower row 203 from the left to the right in order of making time, beginning with the earliest (reference characters 213a and 213b).
Fifthly, the display screen manager 54 displays the made health care screen 71 on the output device 13 in the patient terminal device 2.

At step S443, the display screen manager 54 accepts selection of a tile. Specifically, the display screen manager 54 accepts an arbitrary tile on the health care screen 71 touched by a patient with a finger. The tile touched by the patient may be a tile displayed in any of the upper row, the middle low, and the lower row. In addition, the number of tiles touched by the patient is not restricted. The selected tiles are referred to as “selected tiles” as well. It is now supposed that the selected tile is the tile 212f “the lowest blood pressure 70 mmHg.”

At step S444, the display screen manager 54 displays associated tiles with emphasis. Specifically, first, the display screen manager 54 acquires an information ID of the selected tile. In the example, an M system information ID is acquired.

Secondly, the display screen manager 54 searches the associating information DB 68 (FIG. 10A) by using an M system information vector which has the acquired M system information ID and “P002,” as a search key, and acquires one or a plurality of pertinent records. The acquired records are referred to as “emphatically displayed records” as well.

Thirdly, the display screen manager 54 displays a tile identified by a U system information vector stored in the schedule information (U) column 172 in the emphatically displayed records, a tile identified by an M system information vector stored in the biological system information (M) column 173, and a tile identified by an L system information vector stored in the comment information (L) column 174 with emphasis in a mode which makes mutual relations understandable. As examples of the display with emphasis, coloring the tiles with akin colors, coupling the tiles by lines, providing the tiles with the same mark, and expanding the tiles are conceivable. In case where a plurality of emphatic display records are acquired, it is possible to change the color, the line kind, the mark kind, or tile expansion rate every record. Tiles in an information vector which is not stored in emphatic display records may not be displayed.

By the way, there may be a case where a tile which should be displayed with emphasis and which is not the selected tiles is not displayed on the health care screen 71 in the “fifth” processing of the step S442 (for example, because of a reason why the making time is old). Even in this case, the display screen manager 54 clearly describes time included in display contents of the old tile and then displays the tile in the “third” processing at the step S444. By doing so, the patient can conduct reflection such as “the blood pressure has fallen because I halfheartedly dealt the comment information given by the supporter at least one year before.” Furthermore, the display screen manager 54 may align tiles of an information vector included in the same emphatic display record in the same column along a longitudinal line on the health care screen 71 and redisplay them.

At step S445, the display screen manager 54 displays a difference of biological information. Specifically, first, the display screen manager 54 makes a decision whether biological information is included in the tiles displayed with emphasis. If included, the display screen manager 54 regards the biological information as “comparison destination biological information” and proceeds to “second” processing. If not included, the display screen manager 54 immediately proceeds to step S446.

Secondly, the display screen manager 54 acquires a record (comparison destination record) corresponding to the comparison destination biological information from the biological information DB 63 (FIG. 5).

Thirdly, the display screen manager 54 acquires a record (comparison source record) which satisfies all of the following conditions from the biological information DB 63 (FIG. 5).

(Condition 1)

The comparison source record should have a personal ID and a biological information category in the comparison destination record.

(Condition 2)

The comparison source record should have an acquisition time which is older than an acquisition time of the comparison destination record and which is the closest to the acquisition time of the comparison destination record.

Fourthly, the display screen manager 54 subtracts a value of biological information in the comparison source record from a value of the biological information in the comparison destination record, and displays a result of the calculation with a positive/negative sign added, on a tile displayed with emphasis. The display screen manager 54 may convert a percent obtained by dividing the calculation result by the value of the biological information in the comparison source record to a rate per year by using the number of days elapsed with the acquisition time of the comparison source record taken as a start point and the acquisition time of the comparison destination record taken as an end point. And the display screen manager 54 may display a message like “the lowest blood pressure rises (falls) at a rate of ##% per year” in association with a tile displayed with emphasis.

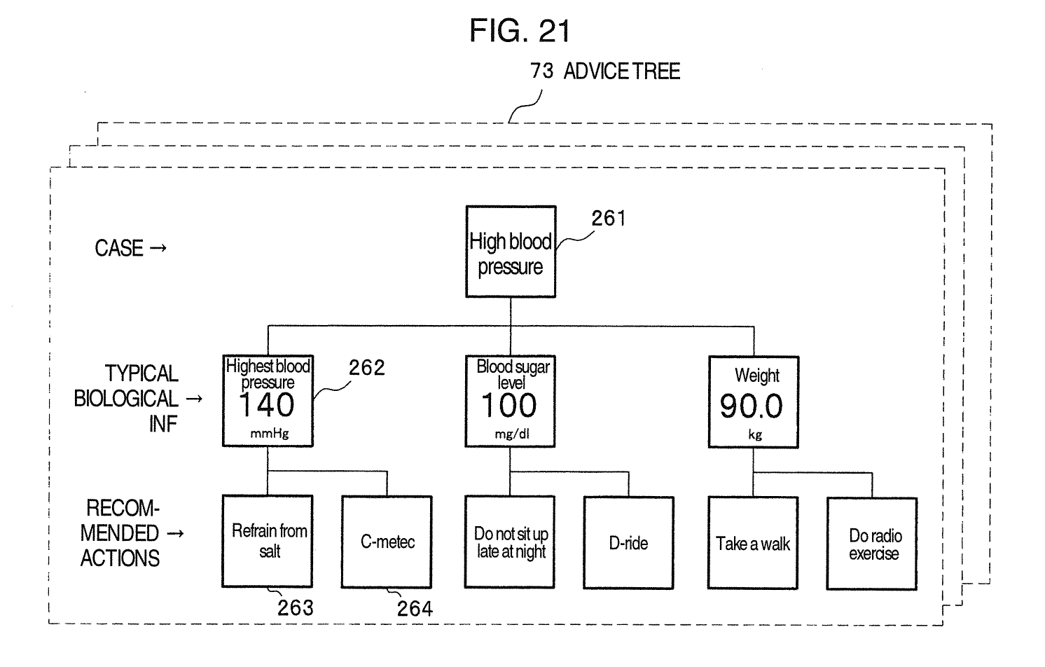

At step S446, the display screen manager 54 displays an advice tree 73 (FIG. 21). The advice tree 73 is a tree diagram which shows relations among a case, typical biological information, and recommended actions hierarchically. For example, the advice tree 73 shown in FIG. 21 has a case “high blood pressure” 261 at a root, has typical biological information “highest blood pressure 140 mmHg” 262 as one of its subordinates, and has recommended actions “refrain from salt” 263 and “C-metec (medicine name)” 264 as its further subordinates. Upon viewing the advice tree 73, the patient recognizes that if the highest blood pressure of himself or herself arrives at a vicinity of “140 mmHg” the patient comes under the case “high blood pressure” and it is necessary to take a meal with salt restrained and take, for example, “C-metec.”

The transmission/reception information manager 51 in the agent terminal device 5 makes a plurality of advice trees 73 and stores them into an advice tree DB (not illustrated) in the auxiliary storage device 35. As for a method for making the advice tree 73, a method of accepting manual inputs of a supporter such as a doctor is the simplest. However, the transmission/reception information manager 51 may routinely refer to external databases (such as home pages of medical institutions, pharmaceutical corporations and the like) via the network and make advice trees by using a known method.

Specifically, if the selected tile is a tile concerning the biological information, the display screen manager 54 acquires an advice tree 73 having the category and its value (or a value which is close to its value in a predetermined range) of the biological information as typical biological information, from the advice tree DB. If the selected tile is a tile concerning the observation information, the display screen manager 54 acquires an advice tree 73 having a word akin to display contents (or a part thereof) of the observation information, as a case. If the selected tile is a tile concerning hospital attending information, medicine taking information, or comment information, the display screen manager 54 acquires an advice tree 73 having a word akin to display (comment) contents (or a part thereof) of the information, as a case or a recommended action. Thereafter, the display screen manager 54 displays the acquired advice tree 73 on the output device in the patient terminal device 2.

At step S447, the transmission/reception information manager 51 in the agent terminal device 5 acquires a perused person ID. Specifically, the transmission/reception information manager 51 searches the family information DB 61 (FIG. 4A) by using the personal ID accepted at the step S441 as a search key in response to an arbitrary order which is input by a patient, and acquires a family ID in a pertinent record. And the transmission/reception information manager 51 searches the family information DB 61 again by using the acquired family ID as a search key, and acquires personal IDs in all of pertinent records.

Secondly, the transmission/reception information manager 51 searches the perusal authority information DB 69 (FIG. 10B), and identifies a patient identified by the personal ID accepted at the step S441 (a patient viewing the health care screen 71) can peruse a tile concerning which member (patient) in the family of the patient himself or herself. In other words, the transmission/reception information manager 51 makes a decision whether there is a record having the personal ID accepted at the step S441 in the peruser ID column 183 and having the personal ID acquired in the “first” processing at the step S447 in the perused person ID column 182. If there is such a record, the transmission/reception information manager 51 acquires a perused person ID in the record.

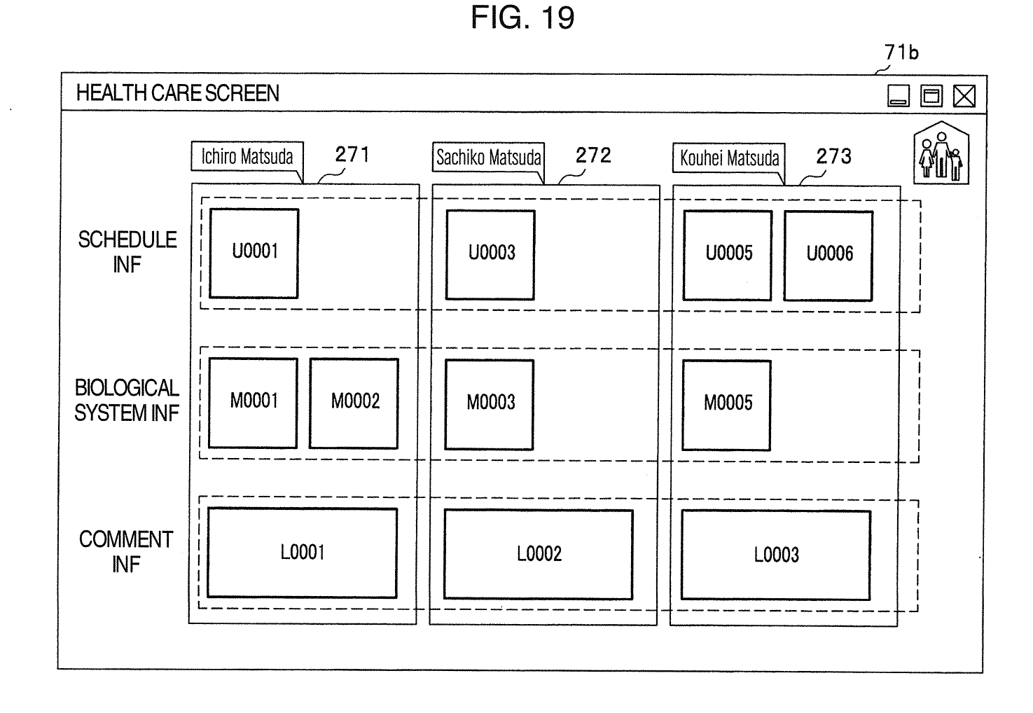

At step S448, the display screen manager 54 in the agent terminal device 5 displays a health care screen 71b (FIG. 19) for family. Specifically, the display screen manager 54 executes the processing at the steps S442 to S446 repetitively for all perused person IDs acquired in the “second” processing at the step S447. At this time, for “the personal ID accepted at the step S441” at the steps S442 to S446, “perused person ID acquired in the “second” processing at the step S447” is read. On the health care screen 71b for family, tiles concerning all patients who can be perused in the family are displayed in personal areas 271, 272, 273, arranged from the left to the right, every patient. A display method concerning individual patients is based upon the personal health care screen 71. Thereafter, the processing proceeds to the step S306 in the general processing procedure.

### <<Perusal Authority Reconsideration Processing Procedure>>

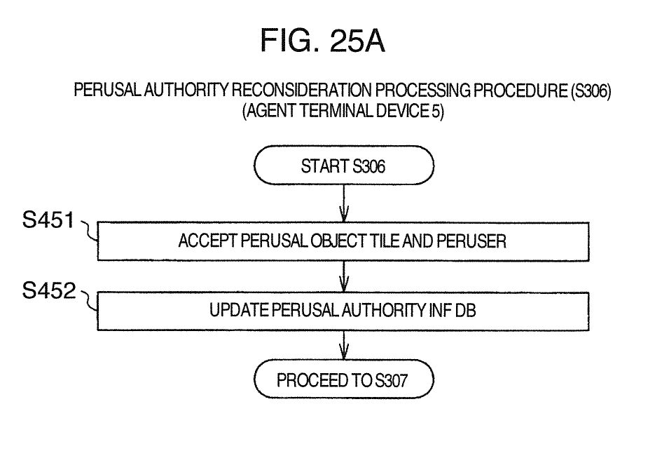

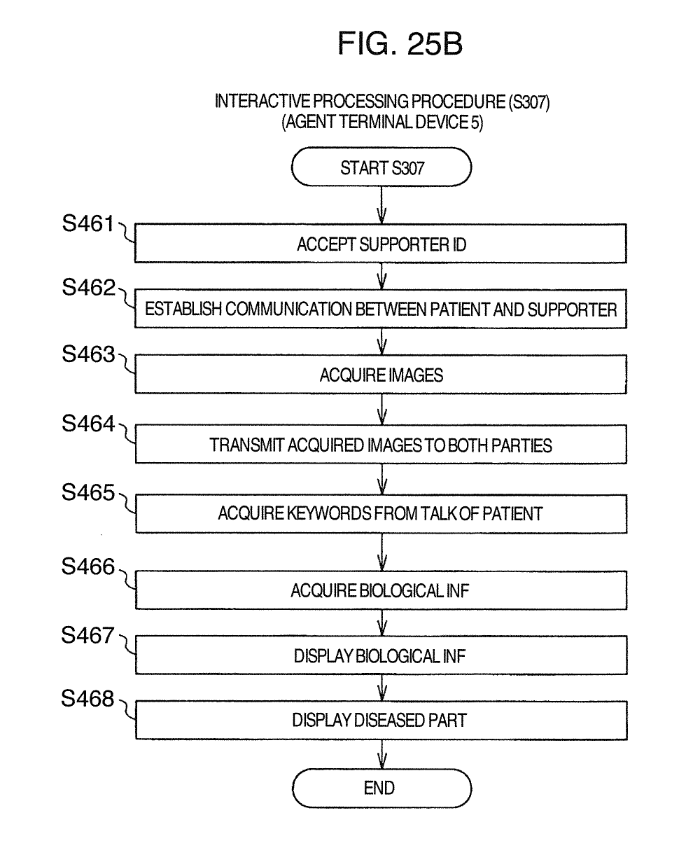

A perusal authority reconsideration processing procedure will now be described with reference to FIG. 25A. The perusal authority reconsideration processing procedure is details of the step S306 in the general processing procedure. As a premise for starting the perusal authority reconsideration processing procedure, it is now supposed that communication is continuously established between the patient terminal device 2 and the agent terminal device 5 and the patient is viewing the health care screen 71.

At step S451, the perusal authority manager 53 in the agent terminal device 5 accepts a perusal object tile and a peruser.

### Example 1

It is now supposed that a patient presses the tile 212b (FIG. 12) “weight 52.3 kg” with a finger and moves the finger to the tile 213a “From home doctor Sakata: - - - ” while pressing the tile 212b. This action indicates that the patient allows the home doctor to peruse the information “weight 52.3 kg.”

### Example 2

As another example, it is supposed that a patient presses a tile 213b “From the agent: In the ward, - - - ” with a finger and moves the finger to the family icon 205 while pressing the 213b. This action indicates that the patient allows all members of the family of the patient to peruse the information “From the agent: In the ward. - - - ”

In these examples, the tiles 212b and 213b are perusal object tiles, and the “home doctor” (the tile 213a) and all members of the family (the family icon 205) are perusers.

At step S452, the perusal authority manager 53 updates the perusal authority information DB 69 (FIG. 10B). Specifically, in the case of the example 1, the perusal authority manager 53 adds “D001” to the peruser ID column 183 of a record in the perusal authority information DB 69 having the personal ID “P002” of the patient who is now viewing the health care screen 71 and stores it. In some cases, some patient does not allow the home doctor to peruse all tiles of himself or herself, but allows the home doctor to peruse only the individual tile 212b “weight 52.3 kg.” In such a case, the perusal authority manager 53 may store “D001” in association with an information vector (an M system information vector) corresponding to the tile 212b “weight 52.3 kg” (not illustrated).

In the case of the example 2, the perusal authority manager 53 first refers to the family information DB 61 (FIG. 4A), acquires a family ID of a record having “P002,” and acquires personal IDs in all records having the acquired family ID. In this case, “P001,” “P003” and “P004” are acquired besides “P002” which indicates the patient herself. Thereafter, the perusal authority manager 53 adds “P001,” “P003” and “P004” to the peruser ID column 183 of a record in the perusal authority information DB 69 having the personal ID “P002” as a perused person ID, and stores it. By the way, it is supposed that “P002” is already stored as an initial value. In some cases, some patient does not allow other members of the family to peruse all tiles of himself or herself, but allows other members of the family to peruse only the individual tile 213b “From the agent: In the ward. - - - ” In such a case, the perusal authority manager 53 may store “P001,” “P003” and “P004” in association with an information vector (an L system information vector) corresponding to the tile 213b agent. In the ward. - - - ” (not illustrated). Thereafter, the processing proceeds to the step S307.

### <<Interactive Processing Procedure>>

An interactive processing procedure will now be described with reference to FIG. 25B. The interactive processing procedure is details of the step S307 in the general processing procedure. As a premise for starting the interactive processing procedure, it is now supposed that communication is continuously established between the patient terminal device 2 and the agent terminal device 5 and the patient desires to interact with an arbitrary supporter.

At step S461, the transmission/reception information manager 51 in the agent terminal device 5 accepts a supporter ID. Specifically, the transmission/reception information manager 51 accepts a supporter ID of a supporter of the opposite party which is input by a patient via the input device 12 in the patient terminal device 2.

At step S462, the transmission/reception information manager 51 establishes communication between the patient and the supporter. Specifically, the transmission/reception information manager 51 establishes communication between a supporter terminal device 3 used by a supporter who is identified by the supporter ID accepted at the step S461 and a patient terminal device used by the patient. It is supposed that after this time on as well, the communication between the patient terminal device 2 and the agent terminal device 5 continues to be established. In other words, it is supposed that after this time on, the agent terminal device 5 can access the supporter terminal device 3 via the patient terminal device 2 or directly and transmit an arbitrary order or the like.

At step S463, the transmission/reception information manager 51 acquires images. Specifically, the transmission/reception information manager 51 transmits an order to the patient terminal device 2 to acquire an image (a moving picture or a still picture) of an upper half of the patient viewed from the front by using the camera 17. In addition, the transmission/reception information manager 51 transmits an order to the supporter terminal device 3 to acquire an image of an upper half of the supporter viewed from the front by using the camera 17.

At step S464, the transmission/reception information manager 51 transmits the acquired images to both parties. Specifically, the transmission/reception information manager 51 transmits an order to the patient terminal device 2 to transmit the acquired patient image to the supporter terminal device 3. In addition, the transmission/reception information manager 51 transmits an order to the supporter terminal device 3 to transmit the acquired supporter image to the patient terminal device 2.

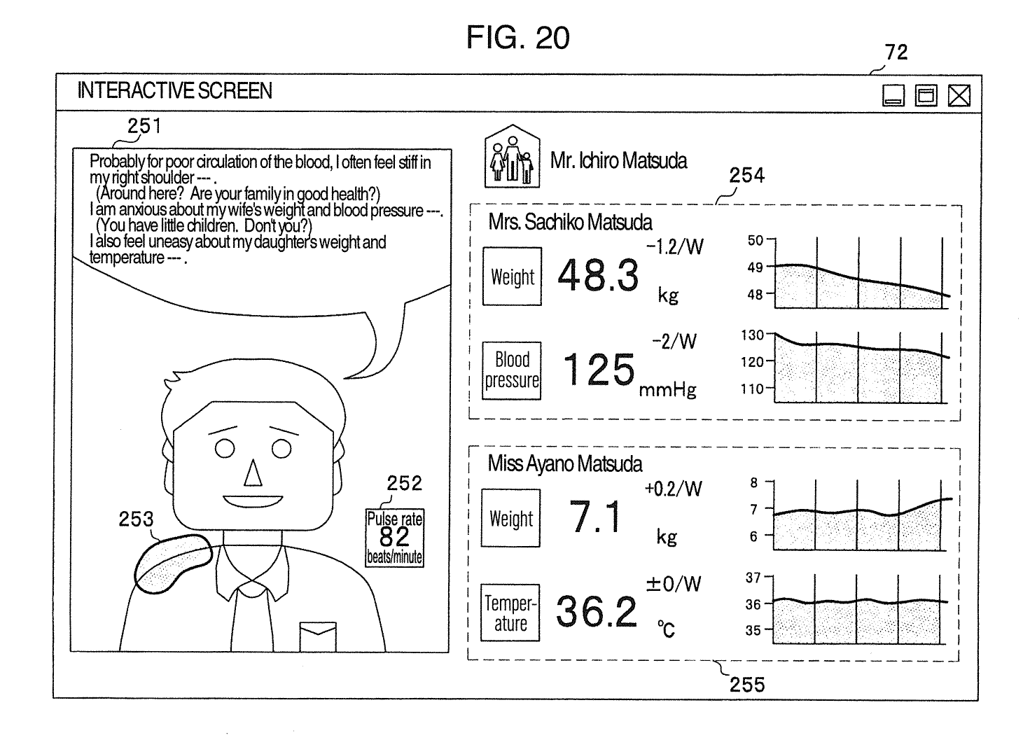

At this stage, the display screen manager 22 in the supporter terminal device 3 displays an interactive screen 72 (FIG. 20) on the output device 13. An image 251 of the patient is displayed on the interactive screen 72 viewed by the supporter. In the same way, the display screen manager 22 in the patient terminal device 2 displays an interactive screen 72 on the output device 13. An image of the supporter is displayed on the interactive screen 72 viewed by the patient.

At step S465, the transmission/reception information manager 51 acquires keywords from a talk of the patient. Specifically, the transmission/reception information manager 51 transmits an order to the patient terminal device 2 to acquire a talk (voice waves) of the patient by using the microphone 19, convert the voice waves to electronic data, and transmit the electronic data to the agent terminal device 5. Thereupon, the transmission/reception information manager 51 receives the transmitted electronic data, converts the electronic data to character data by using a known method, and extracts keywords from the character data by using a known method.

For example, it is supposed that character data after the conversion are “(i) Probably for poor circulation of the blood, I often feel stiff in my right shoulder - - - (ii) I am anxious about my wife's weight and blood pressure - - - (iii) I also feel uneasy about my oldest daughter's weight and temperature - - - .” And it is supposed that keywords after the extraction are “circulation of the blood” and “right shoulder” for (i), “wife,” “weight,” and “blood pressure” for (ii), and “oldest daughter,” “weight,” and “temperature” for (iii). By the way, “ - - - ” means that a time period having a predetermined length has elapsed without a talk. And it is supposed in the ensuing description to make description intelligible that the personal ID of the patient accepted at the step S441 is (not “P002” but) “P001.”

By the way, the expression in a balloon displayed in the column 251 in FIG. 20 is a voice of the patient or a voice of the supporter (in parentheses) listened to by the patient or the supporter via the speaker 20, and characters thereof are not displayed actually on the screen. In other words, a voice picked up by the microphone 19 (38) in the patient terminal device 2 (agent terminal device 5) is reproduced by the speaker 39 (20) in the agent terminal device 5 (the patient terminal device 2) of the opposite party.

At step S466, the transmission/reception information manager 51 acquires biological information. Specifically, the transmission/reception information manager 51 searches the biological information DB 63 (FIG. 5) by using the personal ID “P001” and the keyword “circulation of the blood” as a search key, and acquires a biological information category and a value of biological information in a pertinent record. It is now supposed that “pulse rate” and “82 beats/minute” are acquired. Heretofore, processing for (i) has been described.

And the transmission/reception information manager 51 searches the family information DB 61 (FIG. 4A) by using the personal ID “P001” as a search key, and acquires a family ID in a pertinent record. In addition, the transmission/reception information manager 51 searches the family information DB 61 by using the acquired family ID and the keyword “wife” as a search key, and acquires a personal ID in a pertinent record. It is supposed that the personal ID acquired here is “P002.” The transmission/reception information manager 51 searches the biological information DB 63 (FIG. 5) by using “P002” and the keyword “weight” and/or “blood pressure” as a search key, and acquires biological information categories and values of biological information in all pertinent records. Heretofore, processing for (ii) has been described. Processing for (iii) is similar to the processing for (ii), and consequently detailed description thereof will be omitted.

At step S467, the display screen manager 54 displays biological information. Specifically, the display screen manager 54 displays “pulse rate” and “82 beats/minute” in a column 252 in the interactive screen 72 displayed on the output device 13 in the patient terminal device 2. Heretofore, processing for (i) has been described.

In addition, the display screen manager 54 displays the biological information categories and values of biological information acquired for (ii) in a column 254. For example, if two biological information categories are acquired, they are displayed separately in two rows: an upper row and a lower row. If a plurality of values of biological information are acquired, it is possible to display a value at the latest acquisition time and display a difference (an increase or decrease) between two latest values and a time-series graph of the plurality of values. Processing for (iii) is also similar to the processing for (ii) (a column 255).

At step S468, the display screen manger 54 displays a diseased part. Specifically, the display screen manger 54 accepts, for example, a right shoulder part of the patient image displayed on the interactive screen 72 which is traced by the supporter with a finger. At this time, a diseased part 253 is displayed on the interactive screen 72. And the display screen manager 54 changes the image in the column 251 displayed on the output device 13 in the patient terminal device 2 from the image of the supporter over to the image of the patient with the diseased part 253 displayed additionally.

The display screen manager 54 may identify the position of the diseased part 253 by using the acquired keyword “right shoulder.” For example, the agent terminal device 5 previously stores a front image of an upper half of a human having a standard physique in the auxiliary storage device 35 as a “template image.” Figures representing a right eye, a left eye, a nose, a mouth, a right shoulder, a left shoulder, - - - are stored in places of them on the template image in association with character strings of a right eye, a left eye, a nose, a mouth, a right shoulder, a left shoulder, - - - , respectively. The display screen manager 54 makes other figures on the template image transparent while leaving a figure representing “right shoulder” associated with the acquired keyword “right shoulder.” And the display screen manager 54 may display the template image superposed on the patient image. Thereafter, the general processing procedure is finished.

### <<Weight and Warning>>

The transmission/reception information manager 51 in the agent terminal device 5 monitors the biological information DB 63 (FIG. 5) at all times or periodically. If a value of biological information in a certain record has reached a danger threshold which is previously set for the biological information category, the transmission/reception information manager 51 stores a first weight code in the weight column 128 of the record, and stores a first warning code in the warning column 129 of the record. Furthermore, if a time period previously set for the biological information category has elapsed with a value of biological information in a certain record being in a range between a caution threshold previously set for the biological information category and the danger threshold, then the transmission/reception information manager 51 stores a second weight code in the weight column 128 of a record having a first acquisition time after the elapse of the time period, and stores a second warning code in the warning column 129 of the record.

The caution threshold is set between a value in the normal state and the danger threshold. Furthermore, a weight corresponding to the first weight code is set to be greater than a weight corresponding to the second weight code. In addition, a mode of warning corresponding to the first warning code is set to give a greater sense of urgency as compared with a mode of warning corresponding to the second warning code.

By doing so, the patient can perceive a tile of biological information which is at a danger level at a glance. And for example, when the patient moves a tile concerning biological information while pressing it with a finger at the step S451, the patient can recognize the seriousness.

### <<Grouping of Tiles>>

If the patient can change the arrangement of tiles arbitrarily, it is convenient. For example, it is supposed in FIG. 12 that the patient desires to display the tile 212d of “sleeping hours” close on the right side of the tile 212b of “weight” and display the tile 212f of the “lowest blood pressure” close on the right side of the tile 212d of “sleeping hours.” At this time, the patient moves the tile 212d to close the right side of the tile 212b while pressing the tile 212d with a finger. And the patient moves the tile 212f to close the right side of the tile 212d (just moved) while pressing the tile 212f with a finger. Or the patient talks “tiles should be arranged from the left in order of weight, sleeping hours, and the lowest blood pressure” to the microphone 19. Thereupon, the display screen manager 22 stores the arrangement of them, and thereafter displays tiles in the arrangement unless a cancel order or a change order from the patient is accepted.

### <<Cost Comparison>>

A plurality of ordinary medicines are often taken for the same case. And in general, medicines after the term of license (generic medicines) are inexpensive as compared with medicines which are not generic. The auxiliary storage device 35 in the agent terminal device 5 may store a medicine-by-case DB (not illustrated). In the medicine-by-case DB, the following data are stored.

[Case, (medicine name, unit price), (medicine name, unit price), (medicine name, unit price), - - - ]=[Low blood pressure, (A-metec, ¥200), (E-romsin, ¥150), (F-ride, ¥250), - - - ], [Diabetes, (G-back, ¥500), (H-romsin, ¥400), - - - ], [Cold, (I-back, ¥50), (J-romsin, ¥70), - - -], - - -

The transmission/reception information manager 51 in the agent terminal device 5 automatically makes such a medicine-by-case DB on the basis of an external database. And the transmission/reception information manager 51 monitors the medicine taking information DB 66 (FIG. 8) at all times or periodically, searches the medicine-by-case DB by using a medicine name, keywords, and a remuneration amount included in display contents of a certain record, and acquires a combination of a medicine name which is inexpensive than a remuneration amount in the remuneration amount column 157 and its unit price. For example, if “A-metec,” “low blood pressure,” and “¥200” are used as a search key, the transmission/reception information manager 51 can acquire “E-romsin, ¥150.” Even if “low blood pressure” is missed as search words, “E-romsin, ¥150” corresponding to the same case can be acquired. And the transmission/reception information manager 51 makes a new column: “substitute medicine column” in the medicine taking information DB 66, and then stores the acquired combination into the new column of the record. It is supposed that, for example, “E-romsin, ¥150” in the substitute medicine column of a record in a first line shown in FIG. 8 in this way. Thereafter, for example, at the step S442, the display screen manager 54 in the agent terminal device 5 may display a message (balloon) such as “the price of E-romsin is ¥150” in association with the tile 211e “A-metec after lunch on 14th.” In order to make such a comparison possible, it is desirable that the remuneration amount in the remuneration column 157 also has a value of the unit price.

### EFFECTS OF THE EMBODIMENT

The present embodiment brings about effects described hereafter.

(1) Tiles of the schedule information are displayed in the upper row. Tiles of the biological system information are displayed in the middle row. Tiles of the comment information are displayed in the lower column. If a patient selects an arbitrary tile out of these tiles, tiles associated with the selected tile are displayed with emphasis. Therefore, the patient can understand schedules, comments and the like for biological information in an instant. In addition, the association is implemented automatically by the associating unit 52 which acquires feature words of biological information and the like from an external database and then matches feature words with each other. Therefore, not only the trouble of the patient in conducting manual association can be omitted, but also relevance between tiles is secured objectively.

(2) The transmission/reception information manager 51 determines a weight in moving a tile and a display mode in displaying a tile in accordance with a level of a value of biological information. Therefore, the patient can know seriousness of biological information easily.

(3) The transmission/reception information manager 51 acquires a voice of the patient, and displays biological information relating to the voice. On the screen, therefore, the patient can know biological information of himself or herself desired to be referred to when consulting a doctor or the like, without conducting keyboard inputting or the like.

(4) The display screen manager 54 displays tiles concerning family members collectively every family. Therefore, the patient can conduct health care of all family members easily.

(5) The display screen manager 54 displays the advice tree 73 which shows a case, typical biological information, and recommended actions hierarchically. Even if tiles of himself or herself are not associated with each other, therefore, the patient can know causal relations among a case, typical biological information, and recommended actions easily.

(6) The transmission/reception information manager 51 displays a name of a medicine which is effective for the same case as that of a medicine scheduled to be taken and which is lower in price than the scheduled medicine, and displays a unit price of the medicine. Therefore, the patient can conduct reconsideration of fees for medical treatment easily.

The present invention is not restricted to the embodiment described above, but the embodiment can be changed and executed without departing from the spirit of the present invention.

1. A health care apparatus comprising:
a storage unit for storing a first information group which is a set of a plurality of schedule information pieces, a second information group which is a set of a plurality of biological system information pieces, and a third information group which is a set of a plurality of comment information pieces; and
a controller for associating individual information pieces included in the first information group, individual information pieces included in the second information group, and individual information pieces included in the third information group with each other on the basis of coincidence or resemblance among words included in the individual information pieces,
the controller displaying the first information group in a first area of a screen on an output device connected to the controller,
the controller displaying the second information group in a second area of the screen,
the controller displaying the third information group in a third area of the screen,
the controller accepting arbitrary one selected out of the individual information pieces included in the first information group, the second information group, or the third information group, and
the controller displaying other individual information pieces associated with the selected individual information piece with emphasis.

2. The health care apparatus according to claim 1, wherein the controller compares feature words of individual information pieces included in the first information group, feature words of individual information pieces included in the second information group, and feature words of individual information pieces included in the third information group with each other, and thereby associates the individual information pieces with each other.

3. The health care apparatus according to claim 2, wherein the controller acquires the feature words from an external database on the basis of the individual information pieces.

4. The health care apparatus according to claim 3, wherein the controller determines a weight at time when moving a figure which represents an individual information piece included in the second information group on the screen, and a display mode of the individual information piece included in the second information group, on the basis of a magnitude relation between a value of the individual information piece included in the second information group and a predetermined threshold.

5. The health care apparatus according to claim 4, wherein
the controller accepts a talk of a person who peruses the screen on the output device,
the controller compares words included in the accepted talk with the feature words of individual information pieces in the second information group, and acquires individual information pieces relating to the talk out of the second information group, and
the controller displays the acquired individual information pieces on the screen.

6. The health care apparatus according to claim 5, wherein
the storage unit stores a patient in association with a family to which the patient belongs,
the individual information piece is associated with the patient, and
the controller displays, on the screen perused by a patient belonging to a certain family, the individual information pieces concerning other patients belonging to the family.

7. The health care apparatus according to claim 6, wherein
the storage unit stores a plurality of trees which represent a case, typical biological information, and recommended actions hierarchically,
the controller accepts selection of the figure, and
the controller identifies a tree relating to an individual information piece represented by the figure accepted in selection out of the plurality of trees, and displays the identified tree on the screen.

8. The health care apparatus according to claim 7, wherein
the schedule information comprises a name and a unit price of a medicine taken by the patient,
the storage unit stores names and unit prices of a plurality of medicines every case,
the controller acquires a name and a unit price of a substitute medicine which is same in case as the taken medicine and which is lower in unit price than the taken medicine, and
the controller displays the acquired name and unit price of the substitute medicine in association with the taken medicine.

9. A health care method using a health care apparatus comprising a storage unit and a controller,
the storage unit storing a first information group which is a set of a plurality of schedule information pieces, a second information group which is a set of a plurality of biological system information pieces, and a third information group which is a set of a plurality of comment information pieces, and
the controller associating individual information pieces included in the first information group, individual information pieces included in the second information group, and individual information pieces included in the third information group with each other on the basis of coincidence or resemblance among words included in the individual information pieces,
the controller displaying the first information group in a first area of a screen on an output device connected to the controller,
the controller displaying the second information group in a second area of the screen,
the controller displaying the third information group in a third area of the screen,
the controller accepting arbitrary one selected out of the individual information pieces included in the first information group, the second information group, or the third information group, and
the controller displaying other individual information pieces associated with the selected individual information piece with emphasis.

10. A health care program for causing a health care apparatus to function,
the health care program causing a storage unit in the health care apparatus to store a first information group which is a set of a plurality of schedule information pieces, a second information group which is a set of a plurality of biological system information pieces, and a third information group which is a set of a plurality of comment information pieces; and
the health care program causing a controller in the health care apparatus to associate individual information pieces included in the first information group, individual information pieces included in the second information group, and individual information pieces included in the third information group with each other on the basis of coincidence or resemblance among words included in the individual information pieces,
the health care program causing the controller to display the first information group in a first area of a screen on an output device connected to the controller,
the health care program causing the controller to display the second information group in a second area of the screen,
the health care program causing the controller to display the third information group in a third area of the screen,
the health care program causing the controller to accept arbitrary one selected out of the individual information pieces included in the first information group, the second information group, or the third information group, and
the health care program causing the controller to display other individual information pieces associated with the selected individual information piece with emphasis.
